(19) United States
(12) Patent Application Publication
(10) Pub. No.: US 2012/0231437 A1
(43) Pub. Date: Sep. 13, 2012

(54) METHOD AND SYSTEM FOR COLLABORATIVE ON-LINE LEARNING MANAGEMENT WITH EDUCATIONAL NETWORKING

(76) Inventor: Delaram Fakhrai, Laguna Beach, CA (US)

(21) Appl. No.: 13/419,414

(22) Filed: Mar. 13, 2012

Related U.S. Application Data
(60) Provisional application No. 61/452,123, filed on Mar. 13, 2011.
(60) Provisional application No. 61/484,215, filed on May 9, 2011.

(51) Int. Cl. G09B 3/00

(52) U.S. Cl. 434/350

(57) ABSTRACT

Online course and learning material management system and methods are provided where students, instructors, publishers, and industry partners utilize the disclosed systems' databases and networking features to interact and improve learning outcome. The system furthermore allows for networking among students, instructors, publishers, software vendors, and prospective employers.

CLAIM OF BENEFIT TO PRIOR APPLICATIONS

The present Application claims the benefit of U.S. Provisional Patent Application 61/452,123, entitled, “Method and System for Collaborative On-Line Learning Management with Educational Networking,” filed Mar. 13, 2011. The present Application also claims the benefit of U.S. Provisional Patent Application 61/484,215, entitled, “Method and System for Sharing and Networking in Learning Systems,” filed May 9, 2011. The contents of U.S. Provisional Application 61/452,123 and U.S. Provisional Application 61/484,215 are hereby incorporated by reference.

### BACKGROUND

Learning management (including course material management) systems allow for instructors and students to interact and improve the learning experience and efficiency. Instructors are able to post course materials (i.e., handouts, notes, homework questions, solutions, exams, grading, etc.) and enrolled students can access and view relevant materials.

The existing systems are coordinated and offered through the educational institutions. Once a user is no longer affiliated with the institution (e.g., a teacher is no longer employed by the institution or a student is graduated), the user cannot continue interacting with the system. Furthermore, users not directly affiliated (or authorized) by the institution cannot access the system. The educational institutions acquire students to be accepted and registered with an institution in order for them to be able to use the online e-learning systems. For instance a student can have access to the e-learning system of a college only if he/she is a student of that college and also registered in a course. Even when a student is registered with a college and in a course and has access to the college e-learning system, the only instructors and courses the student can see, are the ones he/she is registered for.

Also, if a student is enrolled in several colleges, he/she would need different usernames and passwords to login to the e-learning system for each college. Unregistered individuals cannot have access to the system at all. Furthermore, in the existing e-learning systems students' access to the system is limited to a finite amount of time; e.g., three months after their courses end, or after graduation. Current e-learning systems are either affiliated to an institution or limited to specific subjects (e.g., cooking courses) or functionalities (e.g., providing ratings on instructors). As a result these systems do not have comprehensive databases on students, instructors, courses, materials, assignments, projects, job postings, career opportunities all in one place. Because of this shortcoming, current systems cannot provide statistical analysis and reports on educational issues using the necessary database.

The existing online learning system that are not affiliated with any institution do not work with degree awarding educational institutions such as schools, colleges and universities. These systems do not offer any procedures or techniques to explain any relation or handshaking with educational institutions. There existing systems do not utilize and connect database structures for instructors, students, administrators, grant administrators, courses, materials, software packages, reviews, rankings, employees and job listings from different institutions in one place.

### BRIEF SUMMARY

Some embodiments of the present invention provide an online educational system which is operated (e.g., hosted, maintained) independent of the educational institutions. Users with different functionalities regardless of their affiliation with any institution sign up with the system and conduct their tasks. Users can have affiliations with multiple institutions, e.g., a student user can be registered in multiple courses offered in two different colleges. The student user uses the same account to access all his/her courses. Another example is an instructor user who teaches in two different institutions and still all his/her information and data are under one account in the system. In some embodiments of the invention, when users sign up with the disclosed system the users have access to all the available database including instructors, courses, materials, reviews, etc. The system uses an accessibility matrix to enable the users to manage the accessibility of their information. The users only need one username and password to sign in to the system. The users have access and can view all the courses they have taken at different years with different instructors in one place, under one account. All educational and career history of a user are stored and managed under one account.

Some embodiments do not require affiliation to join but provide mechanisms to add affiliations with one or more institutions if a user wishes to do so. For instance, a user first creates an account without any affiliations; the user then adds affiliation for himself/herself or for another user or for an offered course when (i) for course affiliation, a user creates a course under his/her account and assigns an affiliation to that course, however that affiliation only takes effect once confirmed by the administrator user for that institution; some embodiments allow a course to be affiliated with multiple institutions at the same time; some embodiments allow an affiliated course also be offered as unaffiliated course to users wishing to take the course without affiliation from any institutions (ii) the user is an instructor and is asked by an institution administrator to make that course affiliated to an institution (either exclusively or non-exclusively), (iii) a student or instructor user chooses to affiliate himself/herself explicitly to an institution, (iv) the system tracks the courses enrolled in by the student user and assumes affiliation between the user and all those institutions that the courses are affiliated with, (v) the user is a student and receives a request from institution administrator to grant request to either student's results in a particular course or the whole student account, (vi) the user is institution or grant administrator and either asks individual instructors or individual students for access authorization to affiliated courses, and (vii) the user is an instructor (unaffiliated with the institution) and adds or offers a course and signs up affiliated students to his/her course as a credit course towards those students' degrees (this is applicable, e.g., when degree-awarding institutions outsource offering and management of some courses to an outside instructor).

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawing, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates a sign up page in some embodiments of the invention.

FIG. 2 conceptually illustrates an exemplary registration page in some embodiments of the invention.

FIG. 3 conceptually illustrates an example of a page displayed on a user electronic device to allow a registered user to add different functionalities in some embodiments of the invention.

FIG. 4 conceptually illustrates examples of different functions that a user with student functionality can perform in some embodiments of the invention.

FIG. 5 conceptually illustrates the actions the student can perform after a course is selected from the list of ongoing courses in some embodiments of the invention.

FIG. 6 conceptually illustrates examples of the actions that a student can perform when the student selects a course from the list of the closed courses in FIG. 4.

FIG. 7 conceptually illustrates a user interface that is provided in some embodiments of the invention after a student selects a link to request enrollment.

FIG. 8 conceptually illustrates a process in some embodiments of the invention for registering and providing services to a user who wishes to act as a student and signs up in courses.

FIG. 9 conceptually illustrates a user interface for signing up a student in a course in some embodiments of the invention.

FIG. 10 conceptually illustrates examples of different functions that a user with instructor functionality performs in some embodiments of the invention.

FIG. 11 conceptually illustrates the actions the instructor can perform after a course is selected from the list of ongoing courses.

FIG. 12 conceptually illustrates the actions the instructor can perform after a course is selected from the list of closed courses.

FIG. 13 conceptually illustrates a user interface for performing assessments management in some embodiments of the invention.

FIG. 14 conceptually illustrates a user interface for managing student enrollments and accesses in some embodiments of the invention.

FIG. 15 conceptually illustrates a user interface for material distribution and publishing in some embodiments of the invention.

FIG. 16 conceptually illustrates a process for registering and providing services to a user who wishes to act as an administrator or wishes to add administrator as an additional role.

FIG. 17 conceptually illustrates a process for adding parent functionality and getting access permission to a student information in some embodiments of the invention.

FIG. 18 conceptually illustrates a process for affiliating a course to one or more institutions in some embodiments of the invention.

FIG. 19 conceptually illustrates a process for affiliating one or more courses with a particular institution in some embodiments of the invention.

FIG. 20 conceptually illustrates a process for affiliating one or more users with a particular institution in some embodiments of the invention.

FIG. 21 conceptually illustrates a process for gaining access to a user information by another user.

FIG. 22 conceptually illustrates a process for automatically identifying affiliations in some embodiments of the invention.

FIG. 23 conceptually illustrates a user interface for accessing the published material in some embodiments of the invention.

FIG. 24 conceptually illustrates a user interface that is provided when a user selects the link to perform customized searches in some embodiments.

FIG. 25 conceptually illustrates a user interface that is provided for viewing course material reviews and ratings in some embodiments of the invention.

FIG. 26 conceptually illustrates a process for a user to publish course material to users outside a class in some embodiments of the invention.

FIG. 27 conceptually illustrates an example of how the interconnections between courses and job postings are used to improve course and instructor assessment accuracy in some embodiments of the invention.

FIG. 28 conceptually illustrates a user interface for providing functionalities specific to employers in some embodiments of the invention.

FIG. 29 shows several examples of the software tools that are provided in some embodiments of the invention.

FIG. 30 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

### I. OVERVIEW

Some embodiments provide new database structures, features, and capabilities as well as new user roles and functionalities to improve the effectiveness of learning systems and to take the learning experience to new levels of interactivity and to enable new learning domains beyond the instructional environments associated with traditional schooling in schools, colleges, and universities. Some embodiments provide new networking and interaction capabilities among ordinary users, students, instructors, administrators, funding agencies, publishers, software vendors, and prospective employers, etc. Some embodiments provide statistical analysis and comparative studies utilizing the sophisticated and comprehensive database structures of the system.

Some embodiments of the present invention provide an online educational system which is operated (e.g., hosted, maintained) independent of the educational institutions. The disclosed online educational system is sometimes referred to in this specification as “the system” for brevity. Users with different functionalities regardless of their affiliation with any institution sign up with the system and conduct their tasks. Users can have affiliations with multiple institutions, e.g., a student user can be registered in multiple courses offered in two different colleges. The student user uses the same account to access all his/her courses. Another example is an instructor user who teaches in two different institutions and still all his/her information and data are under one account in the system. In some embodiments of the invention, when users sign up with the disclosed system the users have access to all the available database including instructors, courses, materials, reviews, etc. The system uses an accessibility matrix to enable the users to manage the accessibility of their information. The users only need one username and password to sign in to the system. The users have access and can view all the courses they have taken at different years with different instructors in one place, under one account. All educational and career history of a user are stored and managed under one account.

The functionality and management of the disclosed embodiments are separated and independent from any institution such that users can register with the system and create accounts regardless of their educational affiliations. However, the embodiments of the invention have the intelligence and the technology to connect and affiliate the users, courses and materials with those institutions whenever needed. Some embodiments also communicate with different educational institutions in order to exchange grades and evaluations.

In the existing prior art online (or e-learning) systems, students' access to the system is limited to a finite amount of time; e.g., three months after their courses end, or after graduation. However, in some embodiments of the present invention the users continue interacting with the system (and other system users through the provided networking tools) even after their enrollment ends with the educational institutions. The users have access to all the old courses, their materials, notes, grades, instructors' information and in general all their past educational and career activities. In addition to student and instructor users, some embodiments of the invention provide and support several additional functionalities and user types such as administrators, employers, publishers, software vendors, etc. Some embodiments provide specialized networking tools and integrated features to enable and improve interactions among all user types and functionalities.

Some embodiments provide an educational and learning management system that is not managed or hosted by individual educational institutions. Instead, the educational and learning management system is utilized as a platform to conduct educational and professional interactions in the context of education centric networking The need for any link to school database or any electronic handshaking with school database is eliminated for users who wish to use the system as unaffiliated users. Although the system eliminates all the needs for any affiliation with any institution in order to join and use the system, some embodiments provide the users (e.g., instructors) with the interface and electronic handshaking when a connection with an institution is desired. For instance, some embodiments provide an interface for instructors who wish to send the students' grades to an institution electronically. Although the system eliminates the need for affiliation in order to sign up and use the system as a user, the system provides tools and capabilities to exploit affiliations data when available for improved service and operation. These embodiments, register instructors and students without a need to have any link or electronic exchange with any universities software and database.

In the disclosed embodiments, a student user has access to much more information (content, courses, assessment results, reviews/ratings, customized suggestions, and customized networking/interactions with many different user roles such as instructors, employers, software vendors, publishers, etc., from multiple institutions as well as independent sources) than prior art systems. For instance, in some embodiments a student who is not registered in a course still can view: the course description, the instructor who is teaching it this semester and instructors who have taught the course before, the books assigned to the course, reviews and ratings of the books, the notes and other materials used in the course and their ratings (in order to have access to the content of the material the student might need a permission from the material creator/instructor), a list of assignments and projects (the student cannot have access to the content until the student is registered in the course but the list shows what is covered in the course), ratings and reviews of the course, ratings and reviews of the instructor, any similar course taught in different institutions, list of job postings which have listed this course as their requirements, etc.

Some embodiments disclose an online learning management and networking system where: (i) students and instructors sign up and create accounts to manage their course materials, learning tools, and course grading independent of their affiliated institutions (e.g., managed, maintained, and hosted by the disclosed system), (ii) the disclosed system is utilized by different users with no coordination with respective educational institutions, (iii) in some embodiments, course enrollment is performed only with mutual interaction of instructor user and prospective student user, (iv) a student user requests the instructor of a course to submit a performance review/evaluation to the student's account (including grades and rankings), (v) the instructor configures the access by other users (enrolled and others) to his/her course material, (vi) the instructor users utilizes the systems' tools and network of users to publish and distribute the course material (e.g., course notes) among other users for free or for a fee, (vii) published course materials and notes are rated/evaluated by other student/instructor users based different criteria, (viii) students and instructor users form networks among themselves and conduct networking tasks by utilizing the educational information elements associated with a user's account.

All course information (course material, notes, grades, reviews, etc.) for student and instructor users are stored under the user's account created in some embodiments. A student user who is enrolling for a new course affiliated with any institution, uses the same account (e.g., the same username and password on the disclosed online learning system) to enroll in new courses. An instructor user who is offering a new course at any institution uses the same account (e.g., the same username and password on the disclosed online learning system) to offer and manage new courses. When users move from one institution to another, the users maintain the same account and access privileges in the disclosed online learning system. The online learning system and the associated software and databases are maintained, operated, and hosted on servers not affiliated with the educational institutions.

For course enrollment a student user sends a request for enrollment in a course to the instructor through the system. The instructor user then reviews and either confirms or rejects the enrollment request. The instructor can search for a student's account in the system and add the student to list of enrolled users. The instructor can add/remove/modify the list of enrolled students.

An instructor in some embodiments programs and configures the list of users (enrolled and others) who can have access to his/her past and current offered courses' material. An instructor can create sub-groups with access privilege to certain course material. For instance, an instructor can allow all students enrolled in certain courses to have access to his/her course material. An instructor can give full public access (i.e., to every registered user of the online learning system) to some his/her course material without requiring enrollment.

Some embodiments provide tools to request and/or gather reviews/comments/evaluations on a student's performance (by his/her instructors) or on an instructor's performance (by his/her students). These reviews are stored and are shared with other member types per account holder's authorization.

An instructor account in some embodiments publishes and/or distributes his/her course material utilizing the network of users of the online learning system. Such materials include course notes, book chapters, full text books, exam samples/solutions, software sample, video/audio clips, handouts, homework questions, solutions, examinations, etc. For-fee materials are published and offered based on per-item use or a flat-rate fixed monthly charge to access a set of material in some embodiments.

The disclosed system allows for rating and assessment of material by registered users (the users who have access to any material). The evaluations are linked and stored in association with the educational profile of the users placing the ratings.

The disclosed system allows for viewing and filtering of evaluation results (for available course material) based on different criteria, including assessments based only on reviews by instructor users, enrolled students in the course, all users, students from certain institutions, students with grades above a limit, student users in a certain percentile of their classes, etc.

Some embodiments provide networking among users by exploiting users' educational profiles for improved networking capabilities and features. For a student user, this includes institutions attended, courses taken, course outcomes. For an instructor user, this includes institutions affiliated with, courses taught, published course material. The links between student and instructor users are utilized to improve the quality and usefulness of networking (social or professional) among users. The networking features include: (i) search capabilities for screening or finding users based on their educational profile, educational /history, or commonality between educational profiles, (ii) special networking among the participants of a course (e.g., enrolled students and the instructors), (iii) special networking capability among student users enrolled in similar courses offered by different instructors/institutions, (iv) special networking capability based on profiles/histories and/or commonalities between educational profiles, and (v) “special networking” including highlighted instant messaging through the system, highlighted email messages, ability to exchange course material, and hold online discussions.

In addition to student and instructor types, the disclosed system supports and enables different user types and functionalities including: “institution administrator”, “grant administrator”, “employer”, “publisher”, “software vendor”, “advertiser”, “parent”, and “admission officer”. Different account types functionalities can coexist under a single login account or can exist under separate login account.

Some embodiments support “institution administrator” and “grant administrator” functionalities where an “administrator” user sends requests to instructor users affiliated with the institution or who are offering courses while affiliated with the institution. For instance, a “grant administrator” user in some embodiments sends requests to affiliated instructor or student users (who have received grants, awards, funding) to gain access to certain data including enrollment statistics, assessment results, and course outcome. Once a request by an “administrator” user is accepted by the instructors, the “administrator” user gains access to certain information related to an affiliated instructor/course including: (i) instructor's ratings/reviews by enrolled students, (ii) course outcome assessments by students (different assessment platforms). Similarly, the request for affiliation can be initiated by the instructors. “Administrator” users can create/port/implement/conduct new set of assessment platforms and questioners for an affiliated course by submitting them to enrolled students and observing the outcome (in addition to standard assessment platform).

Assessment platforms/questionnaires are developed and conducted by the “instructor” users, “institution administrator” users, “grants administrator” users, or are ported or copied from other similar or correlated courses offered by other instructors or institutions (as independent unbiased assessment). Some embodiments provide assessment analysis tools such as (i) performance tracking of an instructor over time and from course to course, (ii) comparison of an instructor's performance against other instructors with comparable offered courses, (iii) performance evaluation based on different assessment platforms, (iv) assessment based on course outcome and grades for different percentiles of enrolled students (top 10% of students, bottom 10% of students, etc.), (v) filter and categorize review and ratings assessment outcome based on rating students' course performance and history. Some embodiment allow for saving, storing, sharing, and emailing of the reports as authorized by effective permissions. The “administrator” user sees a list of all affiliated courses under his/her account. He/she can modify the list by sending requests to affiliated instructors. The “administrator” user can run comparative analysis among the affiliated courses and create cumulative and interdependent performance reports using the data from all affiliated instructors/courses.

The disclosed system maintains a history of student and instructor users' activities. For student users this history log includes the following information related to all past and current enrolled courses: course materials, affiliated institutions, grades, rankings, reviews and feedback by instructors. For instructor users this history log includes the following information related to all past and current offered courses: course materials, affiliated institutions, student reviews, assessments, course outcome, ratings of individual course notes. Users have full control on accessibility of their history information elements. The users configure the authorized users and determine the level and set of information available to other users.

Some embodiments provide data-mining and statistical analysis tools to apply on information elements related to a set of student and instructor users. Data-mining and statistical analysis tools cover features such as: (i) analyzing and categorizing users' profiles in terms of courses taken, technical expertise, skills, grades, rankings, potential future interests in courses and technical-notes, network of linked users, professional and educational trends of other users with common technical profiles, (ii) data-mining of reviews, assessments, ratings of all materials and instructors by other users to extract patterns and trends, and (iii) data-mining and pattern extraction of educational and professional moves by users of similar background/profile.

Some embodiments provide a customizable Application Programming Interface (API) where final grades and list of enrolled students are exchanged (submitted) with the database/servers of the corresponding educational institutions.

Some embodiments utilize methods for identifying and matching similar or relevant courses and course notes. This is done by calculating and updating “correlation matrices” showing the similarity and degree of correlation for material-to-course and material-to-material combinations. The disclosed system allows users to search, identify, and tag and link other course materials as relevant and suitable items for an enrolled course. The tagging information (identified and entered by users) is utilized by the system to improve the accuracy of “correlation matrices”. This is then used to improve the accuracy of course material searching and suggestions.

Some embodiments provide customized search capability that is tuned towards the user's profile and history. Some embodiments provide suggestions to users (students or instructors) on potential helpful course materials that may help/interest them based on analyzing their educational profiles and history. Some embodiments implement an account functionality/type referred to as “employer”.

This functionality is deployed by recruiters and prospective employers of students and instructors. This includes: posting job requirements, delivering job postings to relevant targeted users based on their educational profiles, utilizing the system databases and links to assess the quality of potential candidates.

Some embodiments provide job requirement matching capability based on users' professional and educational profiles and history. This matching includes: (i) associating a job posting requirements with technical background/expertise in terms of courses taken, level of success in certain courses, evaluations/assessments, (ii) associating a job posting requirements with level of success in certain independent examination tests administered by the disclosed system, and (iii) associating a job requirement matching based on similarity and correlation of a user's technical and professional background against those of some “reference” users. Based on level of a job requirement matching, a job posting is delivered to targeted qualified users (potential candidates) and the prospective employer is notified of the level of matching of each candidate based on all above analysis.

Some embodiments allow an employer to create detailed job posting requirements based on courses taken, grades and rankings, assessment by certain instructors, and desired technical skills (which are then mapped and translated to a list of courses). The employers provide feedback to the system on their assessment of their past hires through the disclosed system (level of satisfaction) to enable the system to improve future matches or suggestions. The disclosed system analyses job postings and trends by employers (and their technical requirements) to provide feedback to student users to adjust and optimize their educational direction and profile (e.g., to suggest courses, technical skills, extension courses, etc.). Different fee charging models are supported and offered to prospective employers for allowing them to utilize the system for delivering job posting and targeting and attracting relevant candidates. An employer can add or define job posting requirements based on grading (level of success, ranking, etc.) of students in certain courses. These courses can be either institutional courses or exam-type courses.

Some embodiments provide an account functionality for software vendors and developers for: (i) presenting and marketing their software tools and features to relevant and targeted users and (ii) allowing selected set of users (e.g., enrolled in certain courses) to access and run vendor software remotely (for free or discounted price) on local or remote servers. The system allows for users to store their source codes under their login accounts with the system. Software vendors can offer free access to students that are enrolled in certain relevant courses for the duration of those courses. Alternatively, software vendors can give limited access to students to only run sample source codes provided by instructors. Fee based access can be offered to students over periods of month, semester, year, etc. The disclosed system allows for linking vendor software access to job posting requirements. A software vendor can allow users to access, practice, and train for using a software tool in connection to a job posting requirement. The disclosed system enables software vendors to create training courses (for their tools) along with course notes, exams, grading, and mutual assessments. These training courses are then associated and linked to other courses offered by institutional instructors.

Some embodiments provide a payment processing and delivery tool between content consumers (e.g., a student user) and content providers (e.g., an instructor user, publishing company, software vendors, etc.). Payment scenarios supported includes per-item charging or flat-monthly charging.

Some embodiments provide different access permission configurations including: (i) permissions to enrolled student users by an instructor user to access course materials, (ii) permissions to “institution” or “grant administrator” users by affiliated instructor users to access evaluation/assessment/outcome data, (iii) customizable permissions to published items (e.g., only students enrolled in courses math 101 and algebra 101 are given access to math 201 course material by its instructor), (iv) permissions by a student user to another user (e.g., prospective employers, admissions offices, research advisors) to access his/her academic history (e.g., courses taken, grades, rankings, evaluations/comments by instructors), (v) permissions by an instructor user to another user (e.g., prospective students, prospective hiring schools) to access his/her academic history (e.g., courses offered, course material, rankings/ratings, assessments, course outcomes, evaluation and comments by students), and (vi) customizable permissions by software vendors to allows users to access and run their software offerings (e.g., give special permissions to users in certain geographical regions or students enrolled in certain courses).

The disclosed system can be utilized for different categories of educational institutions (e.g., K-12, high-school, college, medical schools, graduate schools, specialized schools, training schools, company sponsored training courses, extension programs, etc.).

The disclosed system enables independent instructors (with no institutional affiliation) to create courses, market their courses, enroll students, hold exams, and provide grading and feedbacks.

“Publisher” users in some embodiments market and distribute their textbooks and textbook chapters by matching/associating them with offered courses. Ratings by users and recommendations by instructors are collected to rate and evaluate textbooks and textbook chapters.

An instructor can create a course in some embodiments that only includes evaluation exam and grading. Such courses are intended primarily for evaluating students in a specific topic and providing grading, evaluation, ranking to the students. Students consequently share the outcome with prospective instructors, employers, schools.

Some embodiments include advertisement and discount matching and delivery system where: (i) users' educational profiles are analyzed for targeted advertisement and discounting (including: institutions enrolled with, courses taken, educational focus, background, academic field), and (ii) software tools and other products (e.g., computers) linked/associated to courses by instructors/vendors as required/desired items for courses are advertised and marketed to matching enrolled students.

### I. Account Creation and Accessing the Learning Services

Users with one or more roles such as student, instructor, vendor, etc., sign up and use the learning services in some embodiments of the invention without a need to be affiliated with any institutions. This is in contrast with prior art e-learning systems affiliated with educational institutions such as high schools, colleges and universities which require students to be accepted and registered with a particular institution in order to have access to the particular school's e-learning system.

In some embodiments, a user signs up and creates an account with the system. As part of the sign up process, the user selects a unique username and password to access his/her account. The account creation and maintenance is performed independent of any institutions that the user might be affiliated with. For instance, when a user logins to his/her account with the disclosed system, the system allows the user to access all course materials related to his/her past and current courses. When the user moves from an institution to another one, he/she can choose to maintain the same account and access privileges.

Some embodiments provide an online or web interface for interacting with users. The web interface in some embodiments is provided by one or more servers accessible to users through a network such as the Internet. Users utilize their electronic devices (such as computers, tablets, smart phones, personal digital assistants (PDAs), etc.) and utilize browsers or other software applications to access the web interface. In the following sections, several examples of web pages are described that enable the users to access and utilize the services of different embodiments of the invention. A person of ordinary skill in the art would realize that the invention is not limited to the specific details given in these examples.

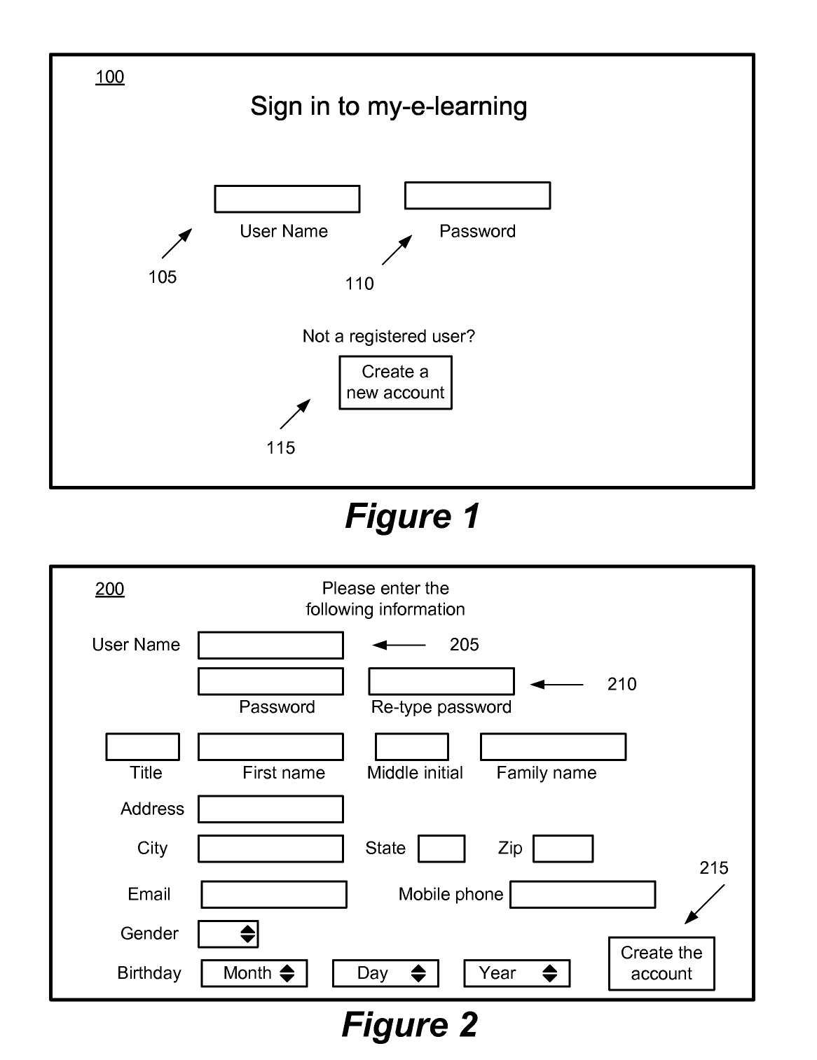

FIG. 1 conceptually illustrates a sign up page 100 in some embodiments of the invention. This is a page that is displayed on a user's electronic device after the user accesses a web address associated with the e-learning system of some embodiments. As shown, existing users are required to enter their unique user name 105 and password 110 to access the system. Other embodiments allow other methods of user authentication such as the use of biometrics readers or electronic password identification generators. As shown, a user that is not a registered member is invited to create an account by selecting a button 115.

FIG. 2 conceptually illustrates an exemplary registration page 200 in some embodiments of the invention. As shown, a new user is simply required to select a unique user name 205 and password 210, enter some personal information such as name, address, email, phone number, gender, birthday, etc., and select a button 215 in order to register with the system. Additional information such as language preference, a visual code to ensure a human is creating the account, etc., are required in some embodiments to facilitate creation of the account.

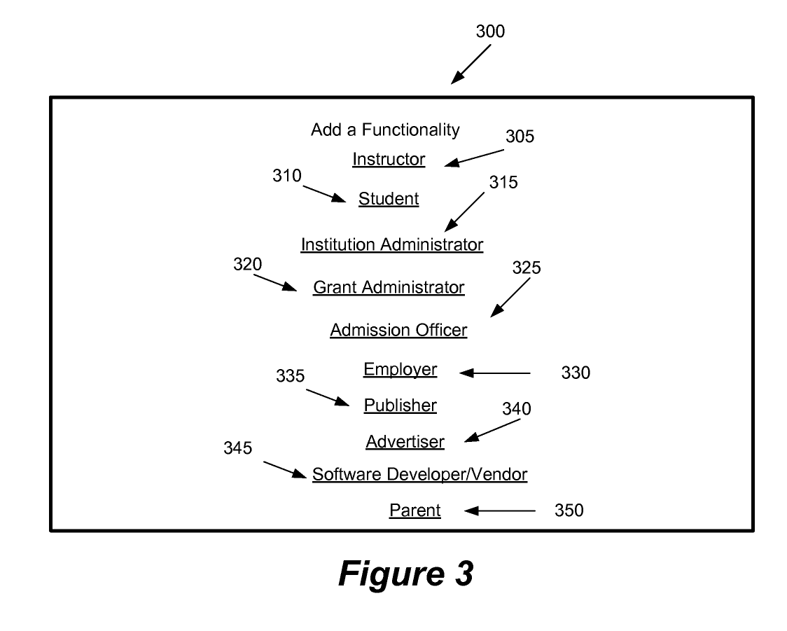

Once a user registers for the first time or logs in as an existing user, the user is provided with tools to add different functionalities in the system. FIG. 3 conceptually illustrates an example of page 300 displayed on a user electronic device that allows a registered user to add different functionalities. The user interface shown in FIG. 3 illustrates instructor 305, student 310, institution administrator 315, grant administrator 320, admission officer 325, employer 330, publisher 335, advertiser 340, software developer/vendor 345, and parent 350 functionalities as examples of functionalities that a user can add to his/her account profile. In some embodiments, a registered user can add several different functionalities. For instance, the same user can have instructor and student functionalities. Since the system stores selected user functionalities, some embodiments only display the functionalities that a user has not yet added to his/her profile. Other embodiments display all possible functionalities and allow the user to remove an existing functionality.

Some embodiments include and maintain a database of all educational institutions (with sub-divisions within an institution (for example Physics Department of USC). In some embodiments when a user signs up with the system, as part of profile creation process, he/she can enter an affiliation or group of affiliations. The user can change this affiliation over time as needed. In the case of instructor functionality, the user can assign affiliation separately for each course being created. If an instructor user adds multiple courses with different affiliation, the user is then affiliated with multiple institutions for that period of time. Furthermore, when the user is not affiliated with any institution the user can choose “non-affiliated” status. This status is used when a user wants to offer a course through the system as an “independent instructor”. Users are given the option to display or hide their affiliation in their profiles. In some embodiments, the system tracks users' affiliations and automatically extracts and utilizes the affiliation data for improved operation and interaction amongst users.

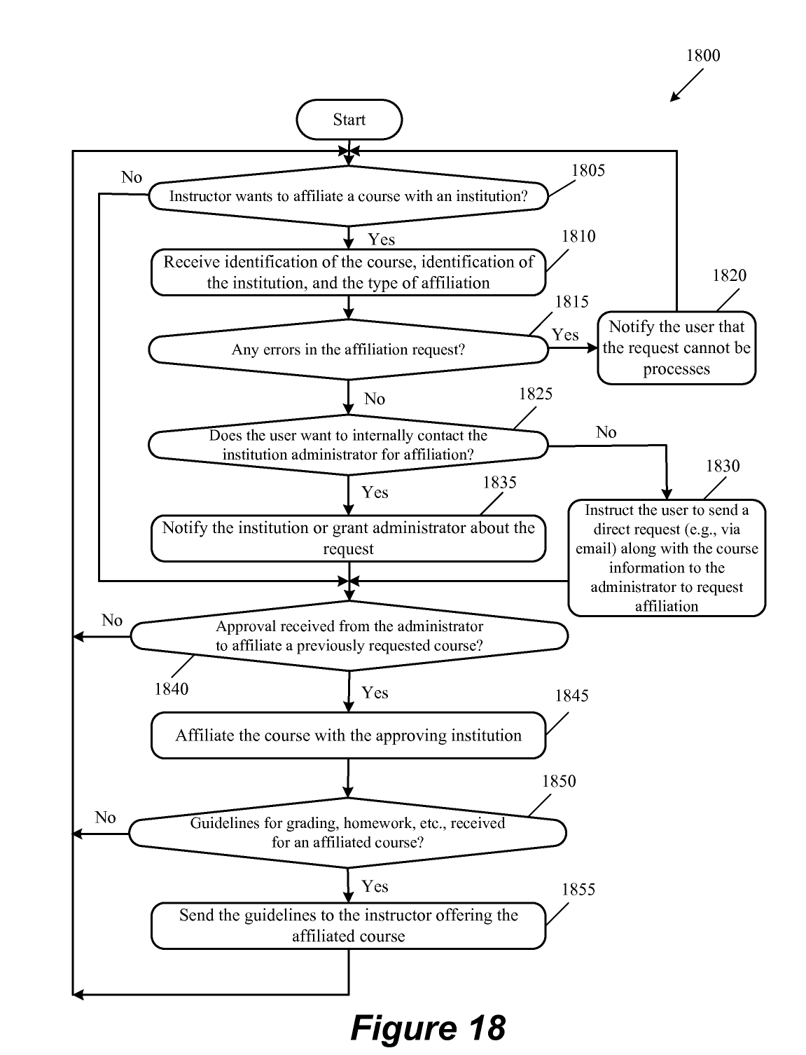

Some embodiments do not require affiliation to join but provide mechanisms to add affiliations with one or more institutions if a user wishes to do so. For instance, a user first creates an account without any affiliations; the user then adds affiliation for himself/herself or for another user or for an offered course when (i) for course affiliation, a user creates a course under his/her account and assigns an affiliation to that course, however that affiliation only takes effect once confirmed by the administrator user for that institution; some embodiments allow a course to be affiliated with multiple institutions at the same time; some embodiments allow an affiliated course also be offered as unaffiliated course to users wishing to take the course without affiliation from any institutions (ii) the user is an instructor and is asked by an institution administrator to make that course affiliated to an institution (either exclusively or non-exclusively), (iii) a student or instructor user chooses to affiliate himself/herself explicitly to an institution, (iv) the system tracks the courses enrolled in by the student user and assumes affiliation between the user and all those institutions that the courses are affiliated with, (v) the user is a student and receives a request from institution administrator to grant request to either student's results in a particular course or the whole student account, (vi) the user is institution or grant administrator and either asks individual instructors or individual students for access authorization to affiliated courses, and (vii) the user is an instructor (unaffiliated with the institution) and adds or offers a course and signs up affiliated students to his/her course as a credit course towards those students' degrees (this is applicable, e.g., when degree-awarding institutions outsource offering and management of some courses to an outside instructor). These and other scenarios are described by reference to FIGS. 18-22 below.

Some embodiments provide the users with several different types of signing up for a course: as enrolled student user, as auditing student user, and as observing user. The instructor configures the level of access for each type. For instance: (i) enrolled students get access to full course material. The emails and messages from an enrolled student user get highlighted in instructor's mailbox. Enrolled students get theirs homework, projects, exams graded and receive a final grade and certification for the course, (ii) auditing students get access to course notes, but may not access homework solutions or submit their homework. An auditing student gets limited interaction privileges with the instructor as configured by the instructor, and (iii) observing students only get access to course notes with limited or no interactions with the instructor.

A. Different User Roles
1. Student Role

A user who wishes to be a student, registers and creates an account with the system (e.g., by using steps described by reference to FIGS. 1 and 2). As part of the sign up process, the student selects a unique username and password to access his/her account with the system. Once the user is registered, the user can add student functionality (e.g., by the user selects functionality 310 in FIG. 3). In some embodiments, the account creation and interaction with the system is performed independent of the institution that the student might be currently enrolled with.

When a student logs into his/her existing account with the disclosed system, the system allows the student to access all course materials related to his/her past and current enrolled classes. Since the system is not affiliated with any institution, when a student moves from an institution to another, the student can choose to maintain the same account and access privileges.

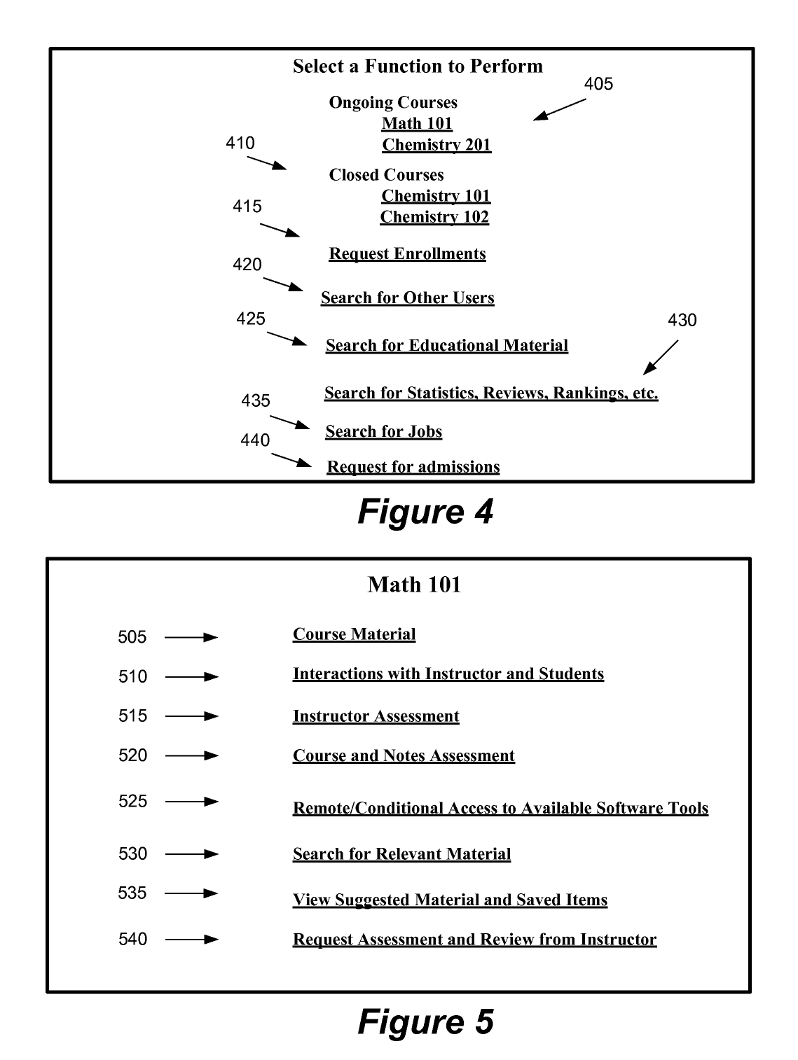

Once the user adds student functionality, the user is provided with a set of functions to perform in student role. FIG. 4 conceptually illustrates examples of different functions that a user with student functionality performs in some embodiments of the invention. As shown, the user is provided with a list 405 of the ongoing courses that the user has signed up with. In this example, the ongoing courses are math 101 and chemistry 201. The student also has access to the closed courses 410 which the student had taken before. In this example, the closed courses are chemistry 101 and 102. The student also can request to enroll in new courses by following the link 415. The student can search for other users such as instructors, students, employers, advertisers, etc. by following link 420 and send them connection request. In this way, student user creates networking links with other users regardless of their user type and affiliations. The student searches for materials, homework, assignments, projects, any merchandise offered by vendors, etc., by following link 425. The student can search for reviews, rankings, statistical analysis, and reports by following link 430. The student can also search for jobs by following the link 435 or to request for admission from one or more institutions by following link 440.

FIG. 5 conceptually illustrates the actions the student can perform after math 101 is selected from the list of ongoing courses 405. As shown, several links 505-540 respectively allow the student to access the course material, interact with the instructor and other students taking math 101, assess the instructor, assess the course and notes, remotely access available software tools, search for relevant material, view suggested material and saved items, and request assessment and review from the instructor.

At the end of a course, a student can request the instructor (e.g., by selecting link 540) to submit a performance review/evaluation to the student's account. This review can include student's grades and rankings in the course. The system would then store those reviews and disclose them to any other account holder in the future per student's request and authorization. In contrast to prior art systems, the embodiments of the present invention gather all grades, rankings, and reviews of a student from different courses taken in affiliation with different institutions in one place. The student user cannot change the grades, rankings, and the content of the reviews and evaluations. However, the student controls the visibility of this information.

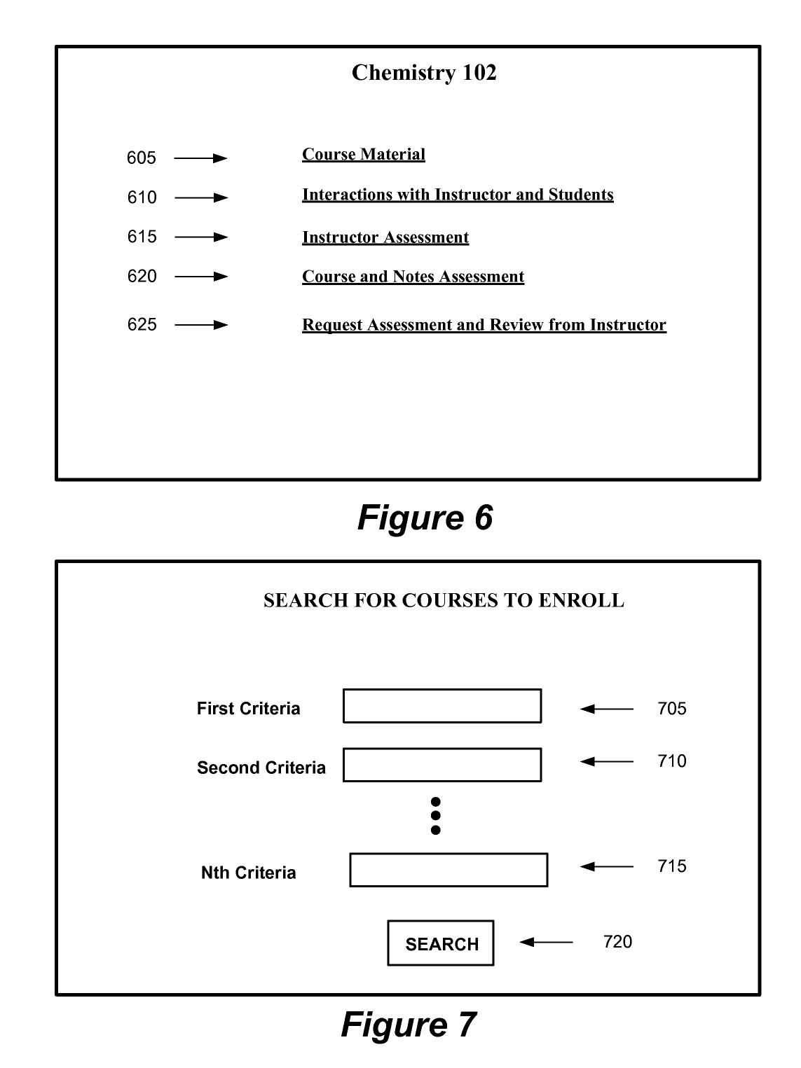

Similarly, selecting a closed course displays a list of actions that the student can perform. FIG. 6 conceptually illustrates examples of the actions that a student can perform when the student selects chemistry 102 from the list 410 of the closed courses in FIG. 4. As shown, several links 605-625 respectively allow the student to access the course material, interact with the instructor and other students that had taken chemistry 102 at that time (the user can network, interact, email to old classmates through this feature), assess the instructor, assess the course and notes, and request assessment and review from the instructor.

Also if the student had enrolled in the course many years ago, some embodiments enable the student to still send a request to the instructor to ask for access to the latest and updated material. For instance, a student user enrolled in a course many years ago (e.g., five, ten, or more), automatically maintains full access to all course material as it was during the enrollment for as long as the user is registered and active with the system. However, if the same course is offered by the same instructor now (e.g., five years later), the student user is given the option to request to gain access to the latest content (notes, homework, etc.). The instructor receives the request and decides whether to approve or reject the request. If approved, the student user sees two sections or tabs under the course that he/she took five years ago. One tab contains the full course material and content snapshot as it was five years ago (archived course notes, homework and solutions, project, forum discussions, and all student user's electronic submissions of homework and project returns). Another tab contains the course material as is in the latest offering of the course (notes, homework assignments, and homework solutions; but obviously without any homework submissions since the student is not enrolled in the latest offering of the course). The “common root” concept described further below is utilized as well for the implementation of this feature. If a student took a course five years ago, the student can still submit a request to have access to latest content of courses with “common root”. Since information about the student is saved, some embodiments do not display links 615-625 once the student has performed those operations.

FIG. 7 conceptually illustrates a user interface that is provided in some embodiments of the invention after a student selects link 415 to request enrollment. As shown, the user can enter several search criteria 705-715 such as course title, instructor name, course instructor assessment results, course material assessment results, etc. A search is performed once the search button 720 is selected. Once the student identifies a desired course, the student can register in the course as described in further detail below.

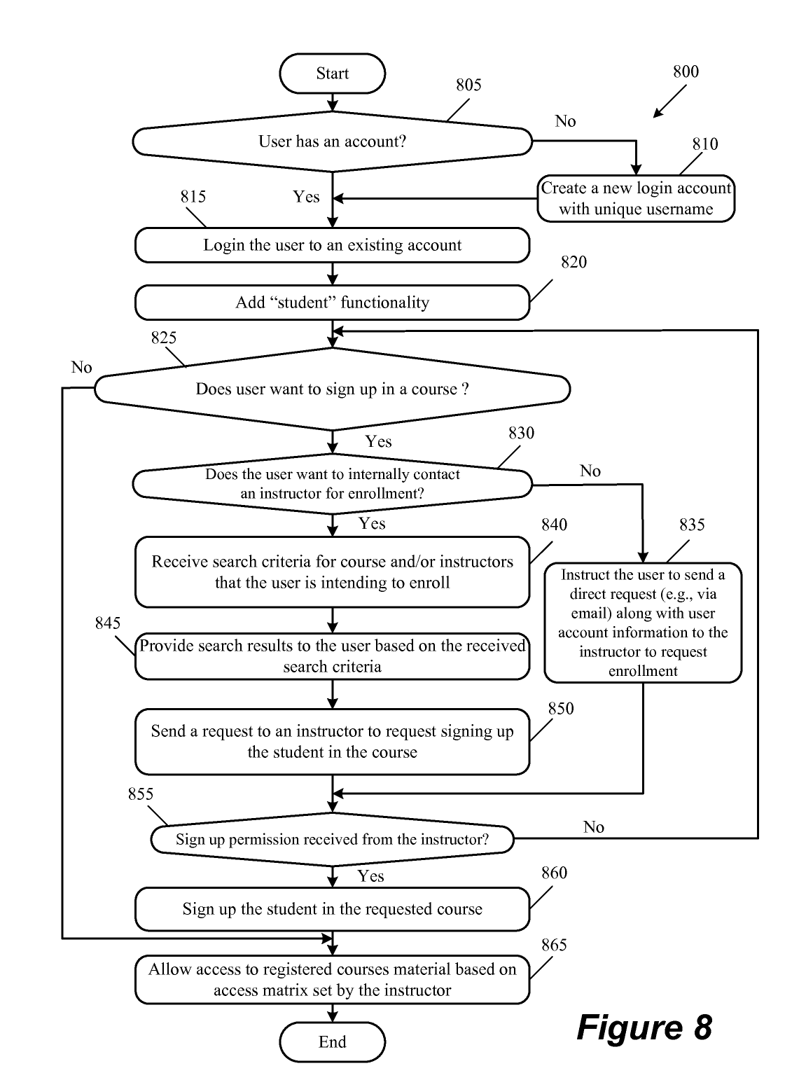

FIG. 8 conceptually illustrates a process 800 for registering and providing services to a user who wishes to act as a student and enroll in courses in some embodiments of the invention. As shown, the process determines (at 805) whether the user has an existing account (e.g., as described by reference to FIG. 1). When the user already has an account, the process proceeds to 815 which is described below. Otherwise, the process creates (at 810) a new account for the user based on a unique user name and a password selected by the user (e.g., as described by reference to FIG. 2).

Next, the process logs in (at 815) the user. The process then adds (at 820) student functionality to the user account (e.g., as described by reference to FIG. 3). For a user that has previously added the student functionality, the process in some embodiments skips operation 820.

The process then determines (at 825) whether the user wants to sign up in a course. When the user does not want to sign up in a course, the process proceeds to 865 which is described below. Otherwise, the process determines (at 830) whether the user wants to internally request course enrollment from an instructor. If not, the process proceeds to 835 which is described below. Otherwise, the process in some embodiments assists the user to selects courses and instructors that the user wants to enroll. As shown, the process receives (at 840) search criteria (e.g., through a user interface such as the interface described by reference to FIG. 7) for course and/or instructors that the student wants to enroll. The process then searches the system databases and provides (at 845) search results to the user based on the received criteria.

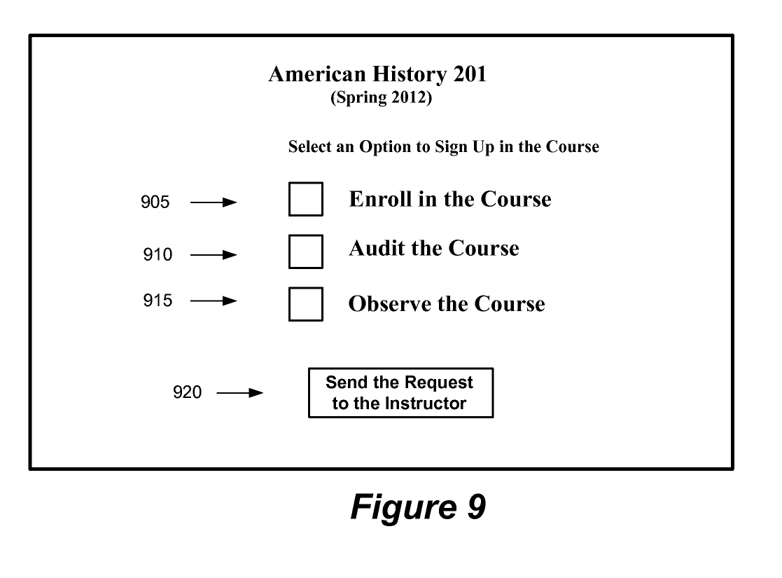

A student user has several options for signing up in a course in some embodiments. FIG. 9 conceptually illustrates a user interface for adding a student to a class in some embodiments of the invention. As shown, once the user identifies a course to register (in this example, American history 201 for spring 2012), the student is given several options for signing up in the course: as an enrolled student user (link 905), as an auditing student user (link 910), and as observing student user (link 915). The student selects one of the options and selects button 920 to send a request through the system to the instructor for signing up in the course. Referring back to FIG. 8, the process sends (at 850) a sign up request (e.g., after receiving selection of button 920) to the instructor to request enrollment to a course selected by the student. The process then proceeds to 855 which is described below.

When the user decides to directly (i.e., without using the system's internal messaging mechanisms) contact the instructor, the process in some embodiments provides (at 835) instructions to the user to directly contact an instructor (e.g., through email) to send an enrollment request along with other required information such as student's user account information (e.g., account username), course information, date and time of the course, etc., to enroll in the course.

Once the instructor receives the request, the instructor configures the level of access for each type. For instance: (i) enrolled student get access to full course material. The emails and messages from an enrolled student user get highlighted in instructor's mailbox. Enrolled students get theirs homework, projects, exams graded and receive a final grade and certification for the course, (ii) auditing students get access to course notes, but may not access homework solutions or submit their homework. An auditing student gets limited interaction privileges with the instructor as configured by the instructor, and (iii) observing students may only get access to course notes with limited or no interactions with the instructor.

At 855, process 800 determines whether sign up permission is received from the instructor. If not, the process proceeds to 825 which was described above. Otherwise, the process signs up (at 860) the student in the requested course. The process then allows (at 865) access to material for the registered courses based on an access matrix set by the instructor. The process then exits.

In some embodiments, instructor student relation has several different levels, each level has specific grading, material visibility and communication privileges: (i) students that are a member of an educational institution offering a course and enrolled in that specific course (ii) students who are taking the course without being enrolled with an affiliated institution, (iii) auditing students who get access to course notes and either have no access to homeworks or cannot submit the homeworks, and (iv) observers (described further below) who only want to access course material. Students can add or audit a course without school intervention by just getting the instructor's approval. The student submits a request to the instructor. The student chooses any of the above applicable levels for sign up and the instructor can approve and designate one of the levels.

As described above, a student has the option to fully enroll, audit, or observe a course. Each one of these sign up types provides the student with different levels of access to the instructor and course material. For instance, the observer sign up type is utilized by a person who only wants to request access or to gain access to materials available publicly through the system. This observer sign up type has limited functionality. For instance, former students who no longer are enrolled in any courses can utilize this account type. Similarly, when a user is not enrolled in a course but wants to access the course material for personal usage and with limited privileges, he/she signs up as observer to request access to a course and get a limited access to material.

In prior art systems, students usually lose their privileges and access to the system when they are not registered in a class anymore. However, in some embodiments of the present invention any individual can create an account (or keep his/her account) and use the system even if he/she was previously affiliated with an institution when the user was taking courses on the online learning system but the user is not a student anymore and is no longer affiliated to an institution. A user can even register in a class (with the instructor's permission) as an observer with different access privileges than an enrolled or auditing student. A user student (when enrolled in a course in the past), can still access his/her account after graduation and access all the course material (including reviews) taken in the past. If a user wants to access a course (but never was a student in that course), the user can still request limited access in an observer role.
2. Instructor Role

Some embodiments allow individual users unaffiliated with any educational institution to create accounts with instructor functionality. These accounts utilize the same learning management capabilities as school-affiliated instructors. These accounts are used for various other courses offered by ordinary individuals and/or non-educational institutions in some embodiments. The course marketing, offering, material distribution, grading, certification, fee-collection (if applicable), and evaluation are all managed by the disclosed system in some embodiments.

A user who wishes to act as an instructor registers and creates an account with the provided system (e.g., by using steps described by reference to FIGS. 1 and 2). As part of sign up process, the instructor selects a unique username and password to access his/her account. In some embodiments, the account creation and maintenance is performed independent of any institutions that the instructor is affiliated with. Once the user is registered, the user can add instructor functionality (e.g., by functionality 305 in FIG. 3).

When an instructor logins to his/her existing account with the disclosed system, the instructor can access and manage all course materials related to past and current courses taught in different institutions through the online learning system. When an instructor moves from an institution to another one, he/she maintains the same account and access privileges. An instructor can view and have access to his/her past and present students accounts, other instructors, publishers, software providers and any other user. He/she can utilize the available database to extract necessary data. For instance an instructor can find the top 1% instructors in his/her field with outstanding course materials and offer them a cooperation to create an educational package.

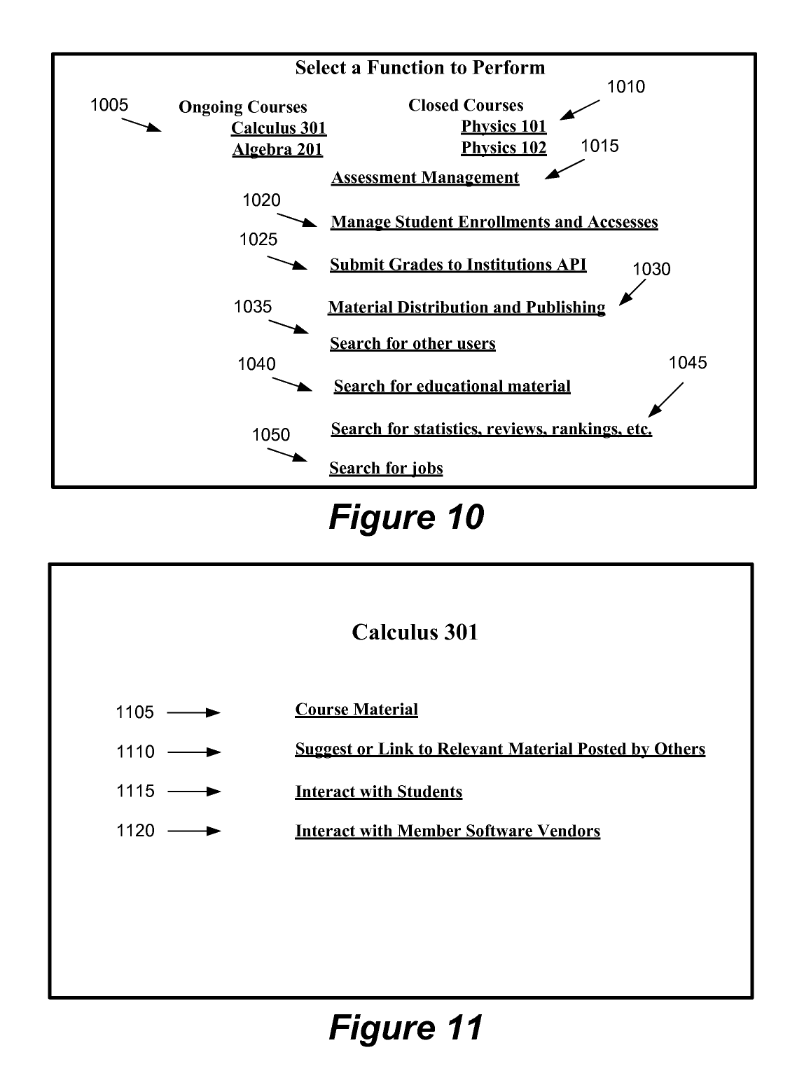

FIG. 10 conceptually illustrates examples of different functions that a user with instructor functionality can perform in some embodiments of the invention. As shown, the user is provided with a list 1005 of the ongoing courses that the user is teaching. In this example, the ongoing courses are calculus 301 and algebra 201. The instructor also has access to the closed courses 1010 which the instructor had taught before. In this example, the closed courses are physics 101 and 102. The instructor also performs assessment management, manages student enrollment and accesses, submits grades to institutions by using application programming interfaces (APIs), and performs material distribution and publishing by following links 1015-1030 respectively.

The instructor can also search for other users such as instructors, students, employers, advertisers, etc., by following link 1035 and sending them connection request. In this way, the instructor user creates networking links with other users regardless of their user type and affiliations. The instructor searches for materials, homework and assignments offered by other instructors, projects, any merchandise offered by vendors, etc., by following link 1040. The instructor searches for reviews, rankings, statistical analysis, and reports by following link 1045. The instructor also searches for jobs by following the link 1050.

FIG. 11 conceptually illustrates the actions the instructor can perform after calculus 301 is selected from the list of ongoing courses 1005. As shown, several links 1105-1120 allow the instructor to access the course material (link 1105), suggest or link to relevant material posted by others (link 1110), interact with students taking calculus 301 (link 1115), and interact with software vendor users (link 1120).

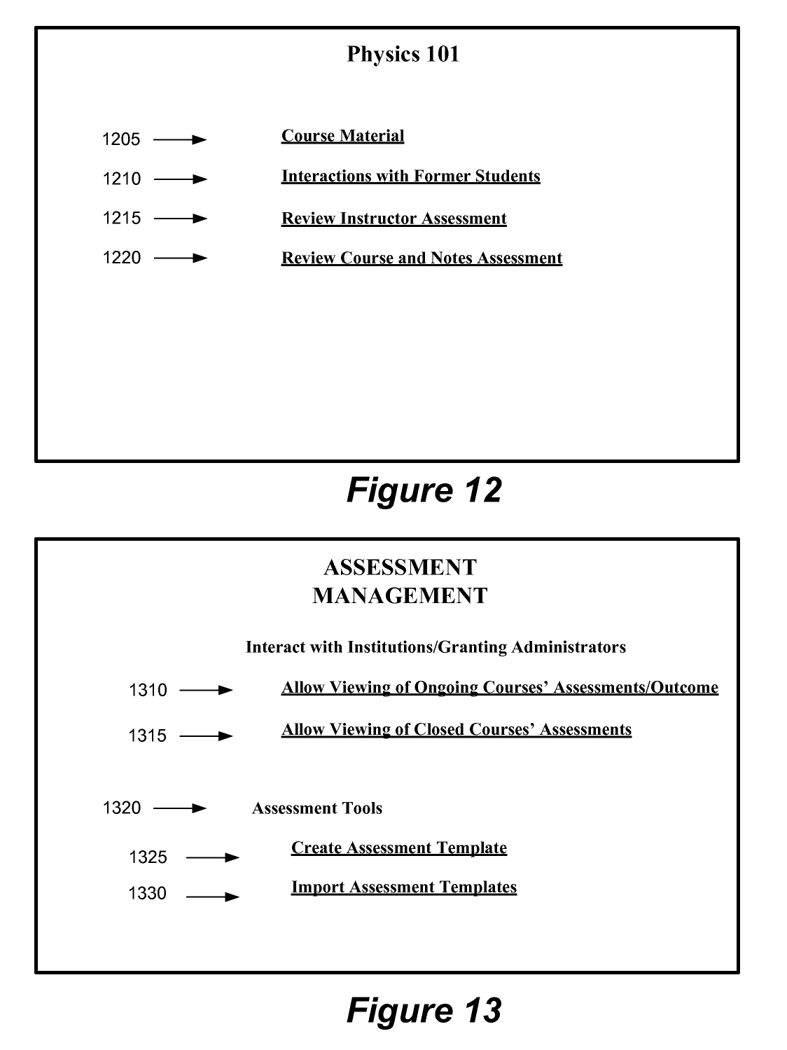

FIG. 12 conceptually illustrates the actions the instructor can perform after physics 101 is selected from the list of closed courses 1010. As shown, several links 1205-1220 allow the instructor to access the course material (link 1205), interact with former students who took physics 101 (link 1210), review student's assessment of the course instructor (link 1215), and review course and notes assessments (link 1220).

FIG. 13 conceptually illustrates a user interface for performing assessments management in some embodiments of the invention. As shown, the instructor can interact with institution administrators and grant administrators. The instructor can allow viewing of ongoing courses' assessments and outcome, grades distributions, assessment templates filled out by students, statistical analysis on assessment returns, (link 1310) or allow viewing of the closed courses' assessments, grades distributions, assessment templates filled out by students, statistical analysis on assessment returns (link 1315). The instructor can also utilize a set of assessment tools 1320. In the example of FIG. 13, the instructor can create assessment templates (link 1325) or import assessment templates, e.g., from other similar courses or from institution or grant administrators (link 1330).

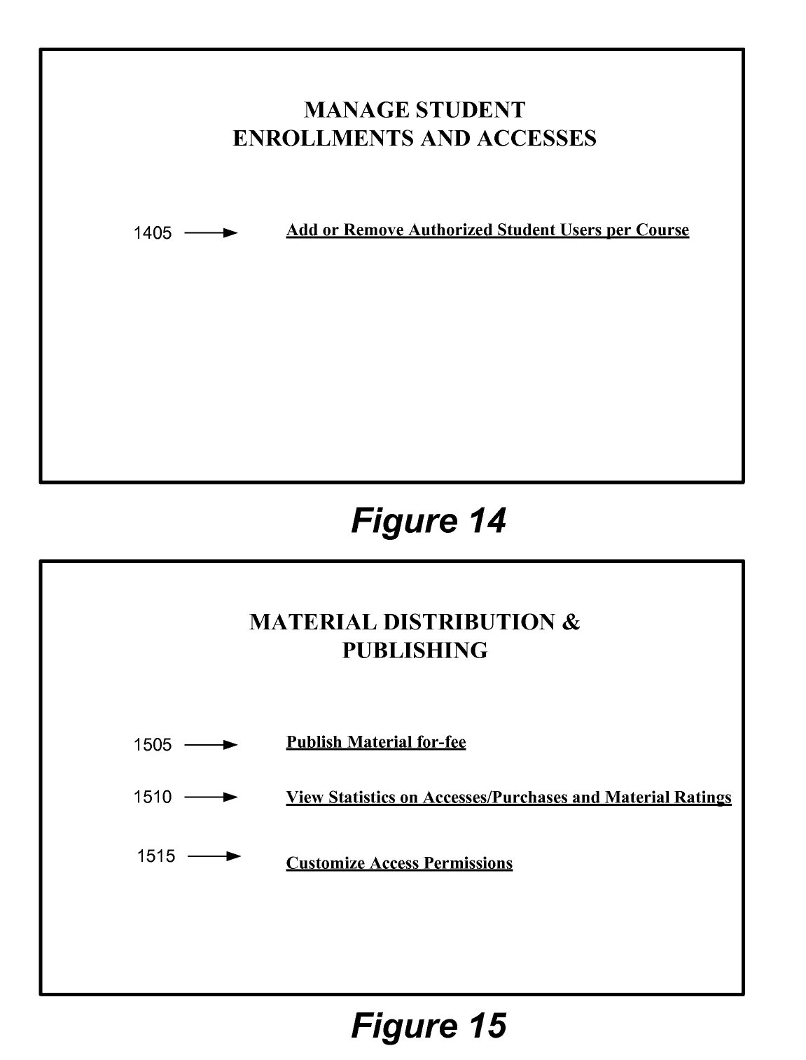

FIG. 14 conceptually illustrates a user interface for managing student enrollments and accesses in some embodiments of the invention. As shown, the instructor has full control for adding and removing students from courses taught by the instructor. The instructor selects link 1405 and is able to review the list of users (e.g., enrolled students, auditing students, observers) currently enrolled in each course taught by the instructor, add new students or observers who have requested to be registered, remove enrolled users, and change users accesses privileges to different course materials.

FIG. 15 conceptually illustrates a user interface for material distribution and publishing in some embodiments of the invention. This interface is used by any user such as instructors, students, publishers who want to publish material. As shown, the user publishes material for fee (link 1505), views statistics on accesses and purchases as well as material ratings (link 1510), and customizes access permissions (link 1515).
3. Institution Administrator Role

Some embodiments support an “institution administrator” account type. This account type is utilized by an institution's Dean, a school department's Chairperson, an institution's manager, institution's director, or school district principal. An institution administrator account user in some embodiments sends a request to affiliated instructor users to gain access to certain information related to some of the courses being offered (or that have been offered in the past) by an instructor. Based on settings by the instructor user, the “administrator” user with proper access can view: (i) instructor's ratings by student users, (ii) instructor's evaluation/assessment results. For example, an instructor user can make the course material private and no non-enrolled user can access the course material. Even in this case, the administrator user can review course teaching material, (iii) enrolled students' comments on instructor's performance, (iv) evolution of course and instructor performance over time, (v) quality of coverage of important concepts and student progress, (vi) exercise and conduct any predefined/customized “instructor assessment” by distributing assessment questionnaires to enrolled students and observing the outcome, and (vii) course material posted by an instructor.

When an institution administrator logins to his/her account with the system, he/she sees a list of courses currently offered by instructors affiliated with his/her institution. The list is created and maintained by sending requests to affiliated instructors by the institution administrator account user (through the disclosed system) and asking them to authorize the institution administrator to have administrative access privilege to their courses. Therefore, the institution administrator user sees the list of courses and can select each course to access information elements and analysis intended to help with his/her duties as, e.g., institution Dean or Chairperson.

Besides having access to the instructors' ratings, evaluations and assessments, an administrator user in some embodiments has access and uses ratings and evaluations of different courses. By using this data, the administrator user assesses courses offered in his/her institution and decides on any necessary improvements or change on any course. An administrator user in some embodiments also has access to the evaluations of courses offered in other institutions (i.e., the evaluations that are available to all users, to the particular user, or to all institutional administrators) and compares them with the courses offered in his/her institution/department. An administrator user also has access to students' accounts registered in his/her institution (only for enrolled courses affiliated with that institution). In some embodiments, once the student enrolls in a course that is affiliated with an institution, that “institution” administrator user automatically gets access to students data related to that course (i.e., the student cannot restrict access to that particular course). In other embodiments, even if the student user enrolls in an affiliated course, the student user still needs to explicitly give access to the “institution” administrator user to access his/her course data.) He/she can view all the information on students including their present and past courses, their grades, their rankings, instructors' comments and etc. For instance, an administrator user who works for a school district can have access to all the information on the schools on his/her district.

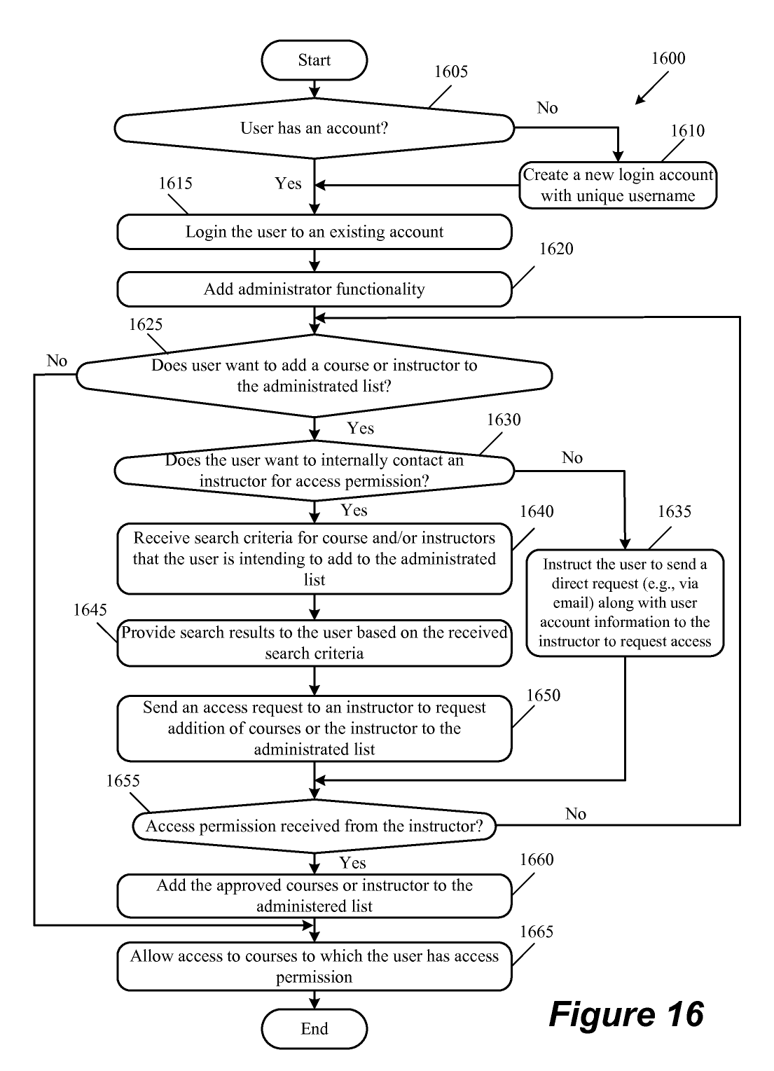

FIG. 16 conceptually illustrates a process 1600 for registering and providing services to a user who wishes to act as an institution administrator or wishes to add institution administrator as an additional role. As shown, the process determines (at 1605) whether the user has an existing account (e.g., as described by reference to FIG. 1). When the user already has an account, the process proceeds to 1615 which is described below. Otherwise, the process creates (at 1610) a new account for the user based on a unique user name and a password selected by the user (e.g., as described by reference to FIG. 2).

Next, the process logs in (at 1615) the user. The process then adds (at 1620) institution administrator functionality to the user account (e.g., as described by reference to FIG. 3). For a user that has previously added the administrator functionality, the process in some embodiments skips operation 1620.

The process then determines (at 1625) whether the user wants to add a course or other users (such as affiliated instructors or students) to his/her list of administered users and courses (the administrator user in some embodiments has the option to add an individual course or a group of courses affiliated with the institution). When an institution administrator adds a course, the instructor for that course sees the request and still needs to approve that request before the course is added to institution administrator user's list. The confirmation, therefore, is a two-step process in some embodiments. When the user does not want to add a course to the list, the process proceeds to 1665 which is described below. Otherwise, the process determines (at 1630) whether the user wants to internally request access permission from an instructor. If not, the process in some embodiments provides (at 1635) instructions to the user to directly contact an instructor or student (e.g., through email) to send a request along with other required information such as institution administrator's user account information (e.g., account username), course information, name or identification of the institution, type of access, etc., to gain access to course or user information. The process then proceeds to 1655 which is described below.

The process in some embodiments assists the user to select courses, instructors, and students that the user wants to add to the list. As shown, the process receives (at 1640) search criteria (e.g., through a user interface) for course and/or instructors that the institution administrator wants to add to the institution's administered list. The process then searches the system databases and provides (at 1645) search results to the user based on the received criteria. The process then sends (at 1650) an access request to a selected user to request addition of courses taught by a selected instructor user, the addition of a selected instructor user, or the addition of a selected student user to the institution administered list.

The process then determines (at 1655) whether access permission is received from the selected user. If not, the process proceeds to 1625 which was described above. Otherwise, the process adds the approved course or the user to the administered list of the administrator. The process then allows (at 1665) access to courses and the users to which the user has access permission as institution administrator. The process then exits.

In some embodiments, multiple institutions use the disclosed system and the system's assessment. In these embodiments, multiple institutions offer the same course on the disclosed online learning system. All these institutions use the same platform which is hosted as an independent website. For the same course, two different institution administrators can ask for different criteria to evaluate and grade the course. For the same course and the same or different students, two different administrators can use different criteria to grade and evaluate performance. Same student can participate in the same course and get different grades from different institutions. This is implemented by the instructor through defining different grading rules for the course based on student users' affiliation. For instance, students affiliated with college C1 are required a score of 80 to receive a grade A in the course whereas students affiliated with college C2 are required a score of 90 to receive a grade A in the course. Some embodiments provide the institution administrators to recommend or enforce assessment packages over a period of time for affiliated courses.
4.Grant Administrator Role

Some embodiments support an account type referred to as “grant administrator”. This account is utilized, e.g., by a funding or granting institution or a public or private organization to evaluate and monitor assessment and outcome of a course that is funded by the funding or granting institution. This account type gains access to information elements related to evaluation and assessment of “authorized courses” by sending a request to instructors offering courses covered by the funding institution (through the system). A grant administrator can also evaluate and monitor assessments and rating on students and instructors who are using their grants. Some embodiments utilize a process similar to process 1600 described in FIG. 16 for registering and providing services to a user who wishes to act as a grant administrator or wishes to add grant administrator as an additional role. In these embodiments, the user adds grant administrator functionality in operation 1620 and the “administered list” in operations 1625, 1640, 1650, and 1660 is the “grant administered” list.

This account role is utilized by granting organizations supporting a student (for a degree, training, extension course, etc.) or supporting an instructor for teaching to a course (or research related to a course). In the case of an organization funding a student user, the grant administrator user requests to add the funded student user to his/her list. Once acknowledged by the student user, the grant administrator user sees the funded student in his/her list (along with the grades, homework returns, project presentations, rankings, comments/reviews by instructors, educational progress over time).

The grant administrator user then attaches the funding information to the student user's account and also requests access to performance of the student user for a period of time starting before the funding and extending to after grant termination. The grant administrator user is provided the option to compare the funded student against other student users (e.g., statistically without disclosing other users' data) with common profiles. For example, the grant administrator compares the funded student against other students in the region, or students with a weak performance in Mathematics in previous quarters, etc. Similarly, an organization that has supported an instructor (for teaching or research) uses the grant administrator role to monitor the performance and outcome of courses offered by a funded instructor (over time and compared to other instructors/courses). Some embodiments provide the grant administrators to recommend or enforce assessment packages over a period of time for affiliated courses.
5. Employer Role

Some embodiments support an account type referred to as “employer”. This account is utilized by employers or recruiters (e.g., corporations or educational institutions). The account type maintains privileges/functionalities to help employers with selectively searching for suitable candidates and with selectively delivering and distributing their job vacancies to student and instructor users. Comprehensive “fee charging” models are supported for employers using the system and accessing student and instructor users and their authorized data. Some embodiments charge the employer users differently depending on the level and details of information available to them. For instance, some embodiments implement the following tiered access (and corresponding fee charge): (i) search users based only on their affiliations and fields of study, (ii) filter users based on their grades and rankings, (iii) filter and access users based on their grades in certain courses, and (iv) access to reviews provided by instructors in the past courses.

Employers in some embodiments interact with potential candidates and have access to candidates' profiles which include their educational and professional history. One of the differences between the embodiments of the present invention and prior art job search websites is that in the embodiments of the present invention there are several types of information: (i) information that the user enters, (ii) information that is entered by other users in the system e.g., the instructors and previous employers, and (iii) data on candidates that is gathered by the system, e.g., comments an instructor can write for the student, the rankings of student in different courses, list of courses taken by a student user (enrolled, audited, and observed courses), quality and performance of instructors who taught the courses, student's grades per course, student's term projects and presentations, etc.

A student user, for instance, can authorize certain employer users to have access to: (i) student's grades for different courses, (ii) rankings per each course, (iii) course homework returns and project presentations, and (iv) reviews left by the instructors. The employer user can also request the potential candidate to allow the system to let the employer contact the instructors and interact and communicate with them.

Some embodiments provide communication links for employers to candidates' references. In prior art systems, an applicant has to provide the information e.g., the name, phone number and email address of their references to the employer. In some embodiments of the present invention, references' names are selectable by the employers (e.g., by clicking on a provided link) and the employer is transferred to their account. Then the employer is able to assess the candidate's references' credentials and send them direct messages. In some embodiments, a user (perspective job candidate) gives “employer-type” access to an employer user. The employer user sees the name of the job candidate user in his/her list (with links, etc.). Depending on level of access authorized by the candidate user, the employer user gets access to that user's account information (reviews, recommendation letters, grades if authorized specifically, etc.).

Employers in some embodiments offer and administrate specialized tests to rank their applicants. For instance an employer in chip design industry can use the system's database and rankings to select the applicants who have ranked top 5% in their circuit design courses and invite them to take an online test. In some embodiments employer users create specialized job requirements in their job postings. For example when an employer user is creating a job posting, the system gives the option of “course specific” requirements to a job posting. For instance, an employer can add a requirement for an applicant for being in the top 10% of financial accounting course or comparable courses suggested by the system to his/her accounting job postings.

Some embodiments recommend eligible candidates to the employers based on the defined requirements and the candidate's qualifications. For instance, if the requirements of a job posting are to have passed two circuit design courses and be in the top 10% in both, the system searches the students database and their grades and rankings and provides the employer the name of students who match the requirements and a link to their accounts.

Some embodiments recommend students to take specific courses based on employers' job requirements. For instance, some embodiments gather information on what courses are mostly required as a job requirement in a job posting (such as in computer engineering job postings) and then suggests computer engineering students to take those courses.

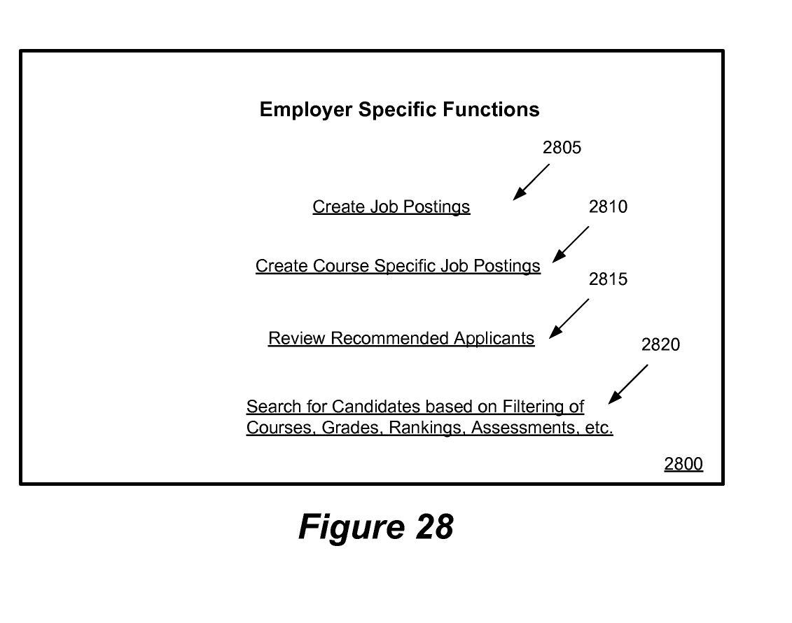

FIG. 28 conceptually illustrates a user interface 2800 for providing functionalities specific to employers in some embodiments of the invention. As shown, an employer can create generic job postings (link 2805), create course and material specific job posting (2810) as described above, review recommended applicants (link 2815), and search for candidates based on filtering of courses, grades, rankings, assessments, etc. (link 2820).
6. Parent or Guardian Role

Some embodiments provide a “parent” role where a parent or a guardian utilizes to create an account. The parent or guardian user in some embodiments sends a request to his/her children (student users) to have access either to all the content of their accounts or specific information such as the records for one or more courses. The parent views his/her child's grades, ratings, progress on the assignments and projects and their overall performance in the class. A parent user can create a connection through the system with his/her child's instructors for direct communications. A parent user can also network through the system with other parent users whose children share a course. In some embodiments, parent users create groups for volunteering and extra curriculum activities.

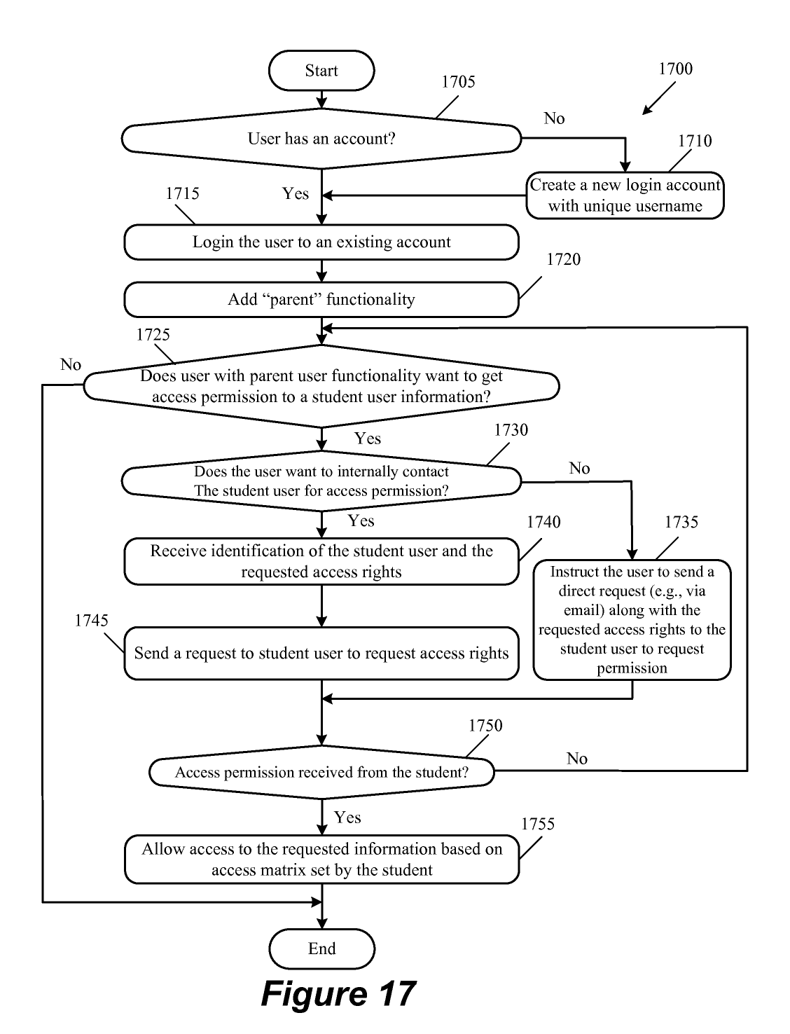

FIG. 17 conceptually illustrates a process 1700 for adding parent functionality and getting access permission to a student information in some embodiments of the invention. As shown, the process determines (at 1705) whether the user has an existing account (e.g., as described by reference to FIG. 1). When the user already has an account, the process proceeds to 1715 which is described below. Otherwise, the process creates (at 1710) a new account for the user based on a unique user name and a password selected by the user (e.g., as described by reference to FIG. 2).

Next, the process logs in (at 1715) the user. The process then adds (at 1720) parent functionality to the user account (e.g., when the user selects link 350 in FIG. 3). For a user that has previously added the student functionality, the process in some embodiments skips operation 1720.

The process then determines (at 1725) whether the user with parent functionality wants to get access permission to a student user information. If not the process exits. Otherwise, the process determines (at 1730) whether the user wants to internally request course enrollment from an instructor. If not, the process proceeds to 1735 which is described below. Otherwise, the process receives (at 1740) identification of the student user and the requested access rights. The process then sends a request to the identified student to request access rights for the requesting parent user. The process then proceeds to 1750 which is described below.

When the user decides to directly (i.e., without using the system's internal messaging mechanisms) contact the student, the process in some embodiments provides (at 1735) instructions to the user to directly contact the student (e.g., through email) to send a request along with other required information such as requesting user's account information and the requested rights.

The process then determines (at 1750) whether the access permission is received from the student. If not, the process proceeds to 1725 to allow the parent user to get access permission to additional student users if the parent user wants to. Otherwise, the process allows (at 1755) access permission based on an access matrix provided by the student user. The process then exits.
7. Admission Officer Role

Some embodiments provide an “admission officer” Role. Admission officers are affiliated with different educational institutions. Users signed up with the system with an admission officer role (e.g., when the user adds admission officer functionality by following link 325 in FIG. 3 to become admission office for a particular institution, school, or department) utilize the system for the evaluation and admission of candidates to their affiliated institutions, schools, or departments. This role is utilized, e.g., by admission offices of colleges and universities in undergraduate and graduate programs. The role streamlines the admission process by using the database and the links and connections maintained by the system.

When a student user wants to apply for an institution, he/she sends a request to an admission officer user for that institution (e.g., by following link 440 in FIG. 4 and requesting admission from one or more institutions). Once the admission officer user accepts the request (in some cases, after receiving an application processing fee payment by the requesting user), the system establishes an “applicant to admission-officer” link between the two users.

Upon the establishment of the above link, the system grants certain access privileges and communication channels to the admission officer user. The authorized admission officer user then gains access to a list of courses (list authorized by the student user) taken by the student user including but not limited to grades, rankings, project submissions/presentations, instructor evaluation of the students, assessment results of courses taken by the applicant student, and evaluation/assessment of instructors taught the courses and/or provided recommendation letters.

The admission officer user also identifies and contacts the student user's instructors in past and current enrolled courses directly through the system. The system tags, groups, and filters such exchanges under “admission office” category for more efficient communication. Furthermore, the admission officer user is provided by the system with the “longer term educational performance/profile/trajectory/employment” of student users who enrolled in the same courses (or courses with “common root” in earlier years). This data is provided in an anonymous way (without disclosing the profiles of those individual student users) and in the form of statistical analysis (e.g., median, top 10%, etc.). Also this statistical data is customized in some embodiments to be taken only over students who have a similar grades/ranking as the applicant student user.

Furthermore, any instructor only needs to fill in a single recommendation or evaluation letter for a student (who enrolled in his/her courses) and that letter is attached and archived into student user's account. The student user can conveniently reuse the same recommendation letter (in electronic format) for applications to multiple schools (as described above) as well as for the use by potential employers with “employer” user roles.
8. Publisher Role

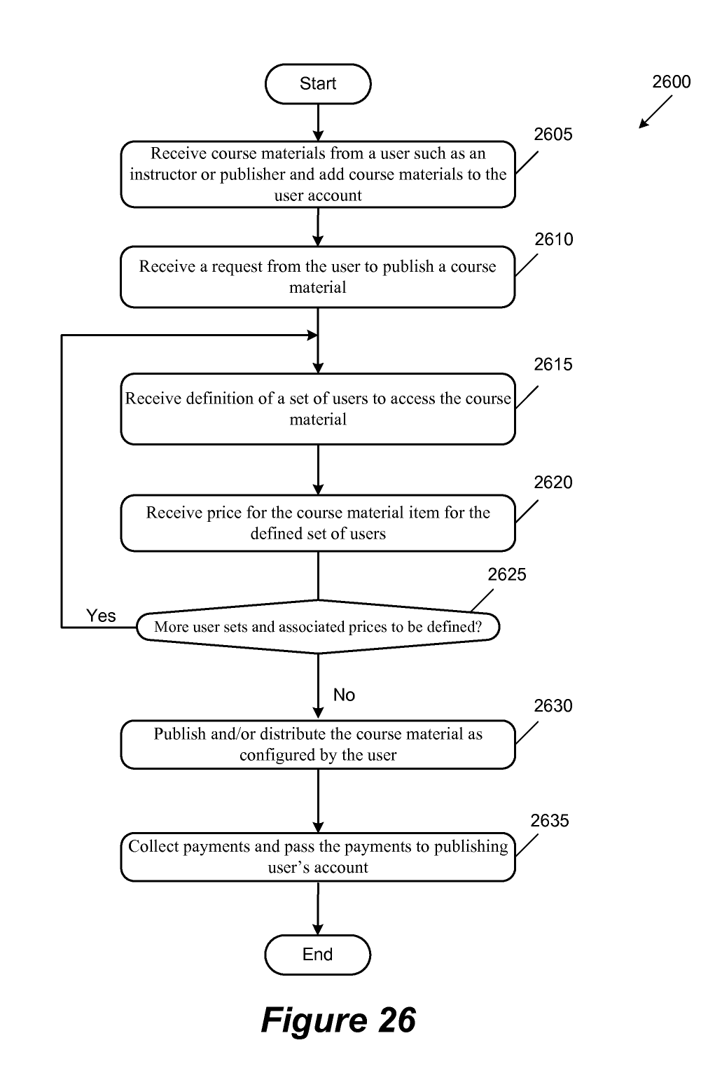

Although any user such as an instructor or a student can publish course material, some embodiments provides a “publisher” account type for users who just want to publish course material. A process for publishing material is described by reference to FIG. 26 below.
9.Advertiser Role

Some embodiments provide an “advertiser” account type for any user who wishes to advertise a service (e.g., person-to-person tutoring) or to sell any products (e.g., stationery supplies). An advertiser role is created to give certain users (such as producers, service providers) the ability to provide highly customized advertisement based on users' educational information elements and their educational networking and connections. For instance, an advertiser can post and distribute targeted ads for students in bottom 10% of certain courses, or students enrolled in certain courses, or instructors teaching certain courses.
10. Software Developer/Vendor Role

The “software developer” account type is used by software development companies for presenting, marketing, and giving remote access to their software tools to student and instructor users in a selective manner. Some embodiments provide interfaces and methods for software development companies for presenting, marketing, and giving remote access to their tools selectively to student and instructor users. These embodiments provide an interface where software companies allow users to remotely connect to internal or third party servers (where those software tools are installed and maintained) and to run those tools remotely on the software codes stored in their user account's space.

The interface in some embodiments is terminal-based while in other embodiments is graphical-based. The software companies are allowed to have different models for presenting and licensing tools. For instance, the companies can give free or discounted access to their tools for enrolled student users in certain courses. The companies can limit free access to a limited use or only to sample example codes provided by the instructor users. More comprehensive access fee calculation and payment models are provided in some embodiments.
11. Multiple User Roles

Some embodiments allow account types and functionalities to co-exist under the same login account or under separate, different login accounts. In the first case, a user registers with the system and adds both student and instructor functionalities to his/her single account (e.g., by using the interface shown in FIG. 3). In this case, the same user has two spaces/planes under his/her account; one with student functionality and another with instructor functionality. In this case the user can exercise both his/her functionalities through a single login account. In the second case, a user creates one login account dedicated to student functionalities and another login account dedicated to instructor functionalities.

B. Creating Affiliation with Institutions

The online learning system in some embodiments is independent from any educational institutions and is not hosted or managed by these institutions. Registering to the online learning system does not require that a student to be registered or affiliated with any educational institutions or an instructor to be hired or affiliated with any educational institutions. At the time of the initial registration, there is no requirement to provide any registration number, employment number, or any other form of identification to prove affiliation with an educational institution. Users registering as instructors can create courses and offer them to anyone in general public who has access to the Internet and registers with the system. Similarly, users registering as student can connect to the online learning system and enroll in courses that are offered to any registered students. In addition, instructors can offer courses and affiliate them exclusively to one or more institutions. Instructors can also offer courses that are affiliated to one or more institutions and at the same time offer the same courses as unaffiliated courses (e.g., to students that are not registered in any educational institutions or do not wish to take any credits from an educational institution). When a student enrolls in a course that is affiliated with one or more educational institutions, the enrolled student can request to be affiliated with one or more of those educational institutions and receive a grade upon the completion of the course from the requested educational institutions. The received grades are also applied towards degree programs in the affiliated educational institutions in some embodiments of the invention.

FIG. 18 conceptually illustrates a process 1800 for affiliating a course to one or more institutions in some embodiments of the invention. In some embodiments, process 1800 is utilized to assist an instructor user to affiliate one or more courses taught by the instructor with one or more institutions. As shown, the process determines (at 1805) whether the instructor wants to affiliate a course with an institution (e.g., when the process receives a selection from the instructor through a user interface to affiliate courses with institutions). If not, the process proceeds to 1840 which is described below. Otherwise, the process receives (at 1810) the identification of the course, the identification of the institution, and the type of affiliation (e.g., exclusive, non-exclusive).

The process then determines (at 1815) whether there are any errors in the affiliation request. For instance, if the identified course is not taught by the requesting instructor, the course identification is wrong, the course has been exclusively affiliated to another institution, etc. If so, the process notifies (at 1820) the user that the request cannot be processed. The process then proceeds to 1805 which was described above. Otherwise, the process determines (at 1825) whether the user wants to internally request to affiliate the course with the institution. If yes, the process sends a request to the user that has institution or grant administrator functionality for the identified institution. The process then proceeds to 1840 which is described below.

When the user wants to directly contact the administrator, the process in some embodiments provides (at 1830) instructions to the instructor to directly contact the administrator (e.g., through a provided email) to send a request along with other required information such as the instructor's username, the course information, the type of requested affiliation, the user's contact information, etc., to the administrator. In some embodiments, once the administrator receives the request, the administrator approves the affiliation and sends the approval to process 1800 through a user interface provided by the online learning system.

Next, the process determines (at 1840) whether approval is received from the institution or grant administrator to affiliate a previously requested course with the corresponding institution. If not, the process proceeds back to 1805 to allow the instructor to affiliate the same course or other courses with more institutions. Otherwise, when the approval for a course affiliation is received, the process affiliates (at 1845) the course with the institution and stores the affiliation information in the system database.

The process then determines if any guidelines and requirements are received from the administrator for an affiliated course. If not, the process proceeds to 1805 which was described above. Otherwise, the process sends (at 1850) the guidelines to the instructor offering the affiliated course. The process then proceeds to 1805 which was described above.

In some embodiments, when a course is affiliated with multiple institutions, the instructor uses different grading methods, different homework and reading assignments, and/or different evaluation packages for students that have registered to the same course but are affiliated to different institutions or have no institutional affiliation. In some embodiments, when an instructor user creates a new course he/she can assign multiple affiliations to the course. Then the student users from several institutions sign up under the same course. One benefit of this mode of operation is that all reviews and assessments provided from students affiliated with several institutions are combined under a single course. In these embodiments, the instructor user uses different grading rules per group of students affiliated with each institution.

Some embodiments allow different types of students to sign up in a course. As described in the specification, students are either enrolled, auditing, or observers. The instructor has the option to define different access privileges for each of these student types. An advantage of the different types of sign up is to give instructors ability to let more students attend their courses without having to provide full service to all of them (such as grading, project review, etc.).

Also, in some embodiments, a course is only created and affiliated with one institution. In these embodiments, when an instructor happens to offer the same course at different institutions, he/she creates two separate courses under his/her account by reusing the same course material. Similarly, an instructor is given the capability to create a new course by using (or reusing) course structure and material from an existing course. For instance instructor I1 is teaching math 101 in year 2012. She realizes that she had taught the same course in 2009. In this case I1 transfers copies of course notes/homework/etc., from her math 101 (year 2009) course to her math 101 (year 2012) course. This is to make the material reuse more efficient and seamless. Also I1 realizes (or is informed by the system) that a similar course has been offered by instructor I2. Then I1 asks I2 to establish an instructor-instructor relation. Then I1 gains access to course material math 101 offered by instructor I2. In this example, I1 can then copy material from I2′s math 101 course as starting point for her course.

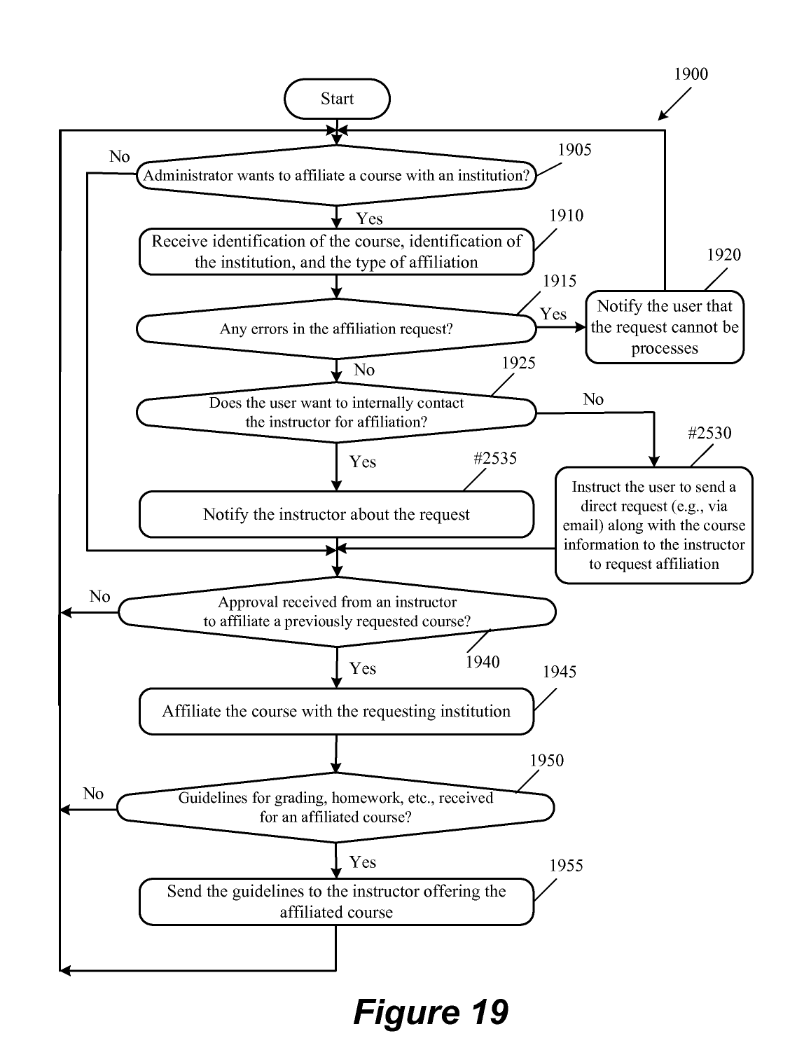

FIG. 19 conceptually illustrates a process 1900 for affiliating one or more courses with a particular institution in some embodiments of the invention. In some embodiments, process 1900 is utilized to assist a user with institution administrator or grant administrator functionality to affiliate one or more courses with the administrator's corresponding institution. These administrators are not the administrators of the online learning system but rather the users that have registered with the online learning system, added administrator functionality, and have affiliated themselves with a particular institution. Administrators from several different institutions can affiliate the same course (or different courses) with their institutions.

As shown, the process determines (at 1905) whether an administrator (e.g., institution or grant administrator) wants to affiliate a course with an institution. If not, the process proceeds to 1940 which is described below. Otherwise, the process receives identification of the course, identification of the institution, and the type of requested affiliation (e.g., exclusive or non-exclusive affiliation).

Next, the process determines (at 1915) whether the affiliation request had any errors. For instance, if the course identification is wrong, the course has been exclusively affiliated to another institution, etc. If so, the process notifies (at 1920) the user that the request cannot be processed. The process then proceeds to 1905 which was described above. Otherwise, the process determines (at 1925) whether the user wants to internally send the request to the instructor that is offering the course. If yes, the process sends (at 1835) a request to the course instructor. The process then proceeds to 1940 which is described below.

When the user wants to directly contact the course instructor, the process in some embodiments provides (at 1930) instructions to the administrator to directly contact the course instructor (e.g., through a provided email) to send a request along with other required information such as the course information, the requesting institution's identification, the type of requested affiliation, the administrator's contact information, etc., to the course instructor. In some embodiments, once the instructor receives the request, the instructor approves or rejects the affiliation and sends the approval or rejection to process 1900 through a user interface provided by the online learning system.

Next, the process determines (at 1940) whether approval is received from an instructor to affiliate a previously requested course. If not, the process proceeds back to 1905 which was described above. Otherwise, the process affiliates (at 1945) the approved course with the requesting institution and sets access rights based on a set of access rights received from the instructor. The process then determines (at 1950) whether guidelines and requirements for grading, homework, assignments, evaluations, etc., have received for an affiliated course. If not, the process proceeds to 1905 which was described before. Otherwise, the process sends (at 1955) the guidelines and requirements to the instructor offering the affiliated course. The process then proceeds to 1905 which was described above. In some embodiments, when a course is affiliated with multiple institutions, the instructor uses different grading methods, different homework and reading assignments, and/or different evaluation packages for students that have registered to the same course but are affiliated to different institutions or have no institutional affiliation.

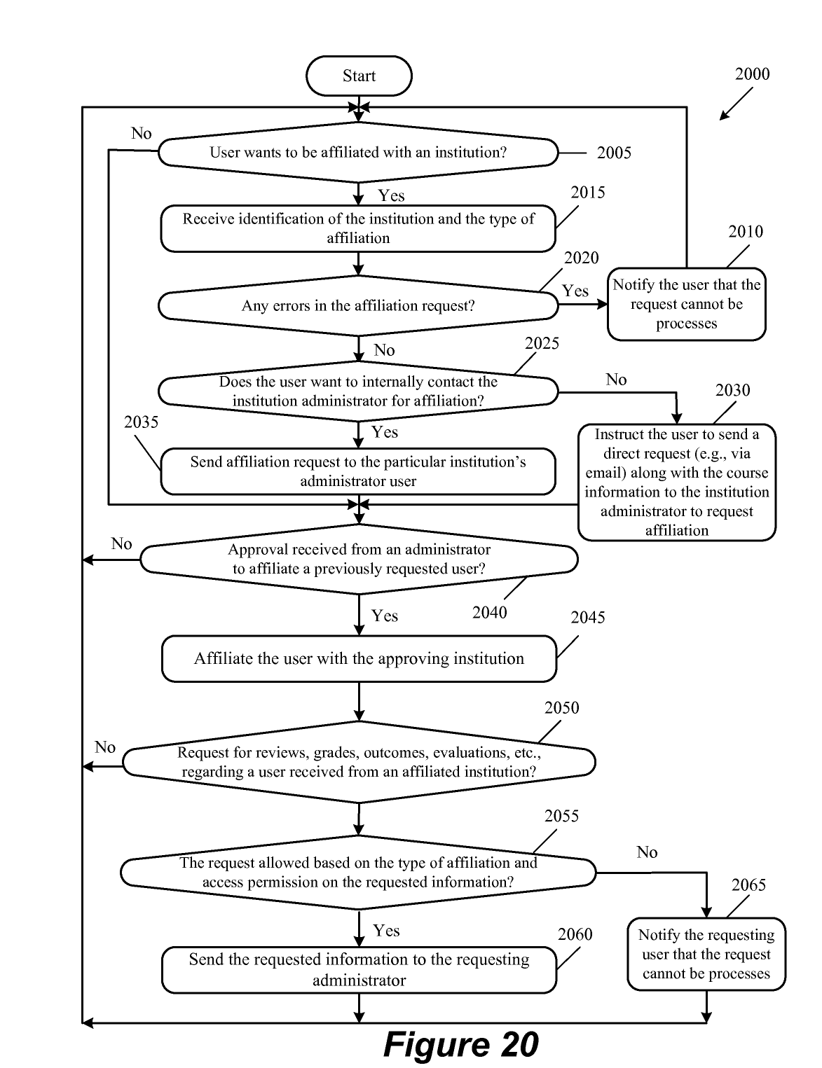

FIG. 20 conceptually illustrates a process 2000 for affiliating one or more users with a particular institution in some embodiments of the invention. In some embodiments, process 2000 is utilized to assist a user that (i) is registered as a student with one or more educational institutions or (ii) cooperates as an instructor with one or more educational institutions to register with the disclosed independent online learning center and add affiliation to specific institutions. In this way, a student registered to the online learning system can get credits with one or more external institutions. Similarly, an instructor that is offering courses in the disclosed independent online learning system, gets affiliation with one or more institutions. In some embodiments, once a student or an instructor is affiliated with one or more institutions, the user sets different options in the user profile to e.g., send grades or evaluations automatically to an administrator user or directly to the affiliated institutions.

In some embodiments, any user can add “student” or “instructor” functionality or role to his/her account. As a student user, the user is not strictly affiliated with any institutions. The student user requests and adds different courses as enrolled, auditing, or observing student. Each requested or added course can be affiliated with different institutions (e.g., offered by instructors affiliated with different institutions). Therefore, the system records in the database that the student user has taken courses affiliated with institutions A, B, C at specific time periods. Similarly, as an instructor user, a user is not strictly affiliated with any institutions. The instructor user can add affiliations to his/her offered courses. When a user with instructor functionality or role signs in, he/she can create courses under his/her account. When creating a course, the user is prompted to optionally assign an affiliation for that course to one or more institutions. That course is then considered affiliated with those institutions upon approval by the corresponding institution administrator. Therefore, the same user can create multiple courses and affiliate each course with a different institution or one course with multiple institutions. In some embodiments, the course can be offered by the user independently as a “tutorial”, “free course”, etc., in which the instructor is considered as “self-affiliated”. In some embodiments, a course can be affiliated to multiple institutions as well as being offered to non-affiliated students.

As shown, process 2000 determines (at 2005) whether the user wants to be affiliated with an institution. If not, the process proceeds to 2040 which is described below. Otherwise, the process receives (at 2015) identification of the institution and the type of requested affiliation (e.g., exclusive or non-exclusive affiliation). Examples of the type of affiliation are: a student or an instructor wants to affiliate himself/herself with one or more institutions, a student wants to sign up and be affiliated to one or more institutions in a one or more courses, an instructor wants to affiliate one or more of the online courses offered by the instructor with one or more institutions.

Next, the process determines (at 2020) whether the affiliation request had any errors. If so, the process notifies (at 2010) the user that the request cannot be processed. The process then proceeds to 2005 which was described above. Otherwise, the process determines (at 2025) whether the user wants to internally send the request to the institution or grant administrator associated with the requested institution. If yes, the process sends a request to the particular institution's administrator user asking for affiliation authorization. The process then proceeds to 2040 which is described below.

When the user wants to directly contact the administrator, the process in some embodiments provides (at 2030) instructions to the user to directly contact the administrator (e.g., through email) to send a request along with other required information such as the user's name, the user's functionality (e.g., student or instructor), the institution's identification, the type of requested affiliation, the user's contact information, etc., to the administrator. In some embodiments, once the administrator receives the request, the administrator approves the affiliation for the corresponding institution and sends the approval to process 2000 through a user interface provided by the online learning system.

Next, the process determines (at 2040) whether approval is received from an administrator to affiliate a previously requested user. If not, the process proceeds back to 2005 which was described above. Otherwise, the process affiliates (at 2045) the approved user with the approving institution. Depending on the type of requested affiliation, either the requesting user is herself/himself affiliated with the approving institution or the requesting user is affiliated with the approving institution in one or more requested courses. The process then determines (at 2050) whether request for grades, outcome, evaluations, etc., regarding a user is received from an affiliated institution.

If not, the process proceeds to 2005 which was described before. Otherwise, the process determines (At 2055) whether the request is allowed based on the type of the affiliation and the type of access permission granted by the user. For instance, some embodiments allow a user (such as a student or instructor) to specifically determine what information is available to which other users. A user, e.g., can allow access to a particular course grade to a grant administrator from a granting institution, allow a particular evaluation to be visible to all instructors or only to instructors affiliated to a particular institution, etc. If the request cannot be allowed, the process notifies (at 2065) the requesting user that the information cannot be provided. The process then proceeds to 2005 which was described above. Otherwise, the process sends (at 2060) the requested information to the requesting administrator (or if applicable directly to a requesting institution). The then proceeds to 2005 which was described above. In some embodiments, a user can be affiliated to multiple institutions, exclusively to one institution, affiliated to multiple institutions as well as being able to simultaneously offer courses (e.g. an instructor) or take courses (e.g., a student) as an unaffiliated user.

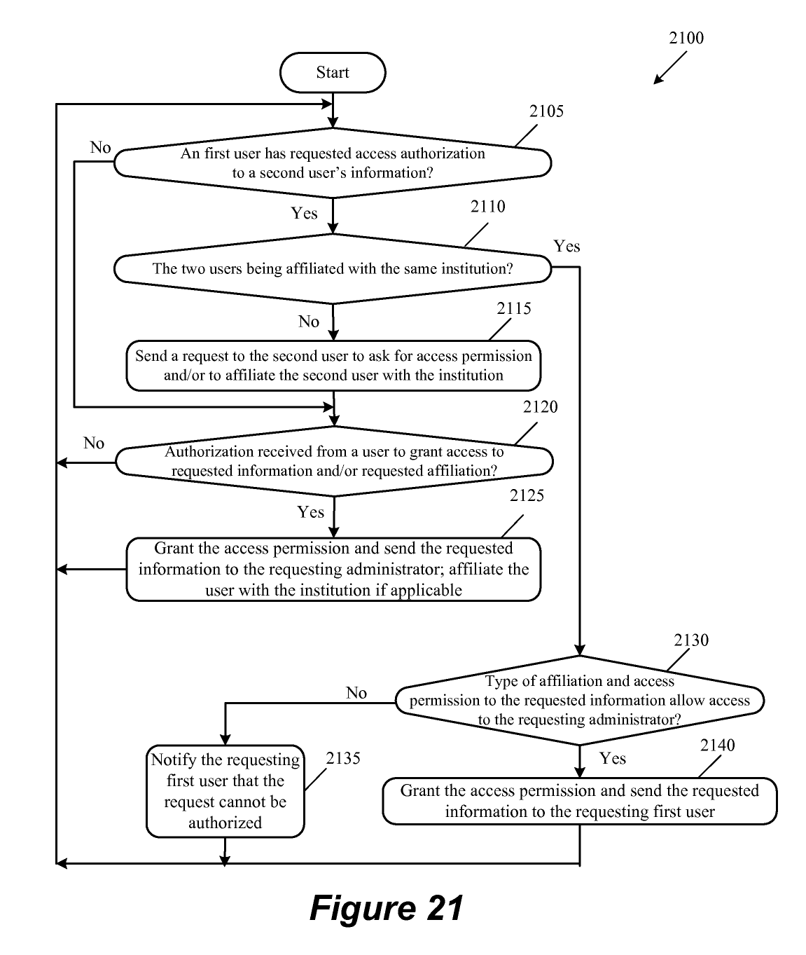

FIG. 21 conceptually illustrates a process 2100 for gaining access to a user information by another user. In some embodiments, process 2100 is utilized to assist a user with institution administrator, grant administrator, or employer functionality to gain access to certain information (such as evaluations, grads, etc.) about another user such as a student or an instructor. The process is also utilized to assist a user with instructor functionality to gain access to certain information about another user such as a student.

As shown, the process determines (at 2105) whether a first user is requesting access authorization to a second user's records and information. If not, the process proceeds to 2120 which is described below. Otherwise, the process determines (at 2110) whether the two users are affiliated to the same institution. For instance, the process determines whether (i) the requesting first user is an institution administrator or grant administrator and the second user is a student or instructor affiliated to the same institution or (ii) the requesting first user is an instructor and the second user is a student and both users are affiliated to the same institution. If yes, the process proceeds to 2130 which is described below.

Otherwise, the process sends (at 2115) a request to the second user to ask for access permission and/or suggesting that the second user becomes affiliated to the same institution as the first user. For instance, the process sends a request to a student that has received a grant from an institution and informs the user that the grant administrator for the granting institution has requested access to the student records (e.g., grades or evaluations) or the granting institution is requiring the student to become affiliated with the institution and to set certain automatic permissions for grade and record reporting. Similarly, a grant administrator user can ask an instructor who has received a grant to authorize access to his/her records for one or more funded courses.

Next, the process determines (at 2120) whether authorization is received from a user to grant access to requested information and/or to make the user affiliated with an institution. If not, the process proceeds to 2105 which was described above. Otherwise, the process grants access permission and sends the requested information to the requesting first user. The process, if applicable, also affiliates the authorizing second user with the requesting institution. The process then proceeds to 2105 which was described above.

The process determines (at 2130) whether the type of affiliation and the access permissions set by the second user allow access by the requesting first user to the requested information. If not, the process notifies (at 2135) the requesting first user that the request cannot be authorized. The process then proceeds to 2105 which was described above. Otherwise, the process grants access permission and sends the requested information to the requesting first user. The process then proceeds to 2105 which was described above. In some embodiments, when a user is affiliated with multiple institutions, the user can set different access authorization for each institution to grant access to particular records, to grant automatic reporting of certain records, to grant access for a certain time period, etc.

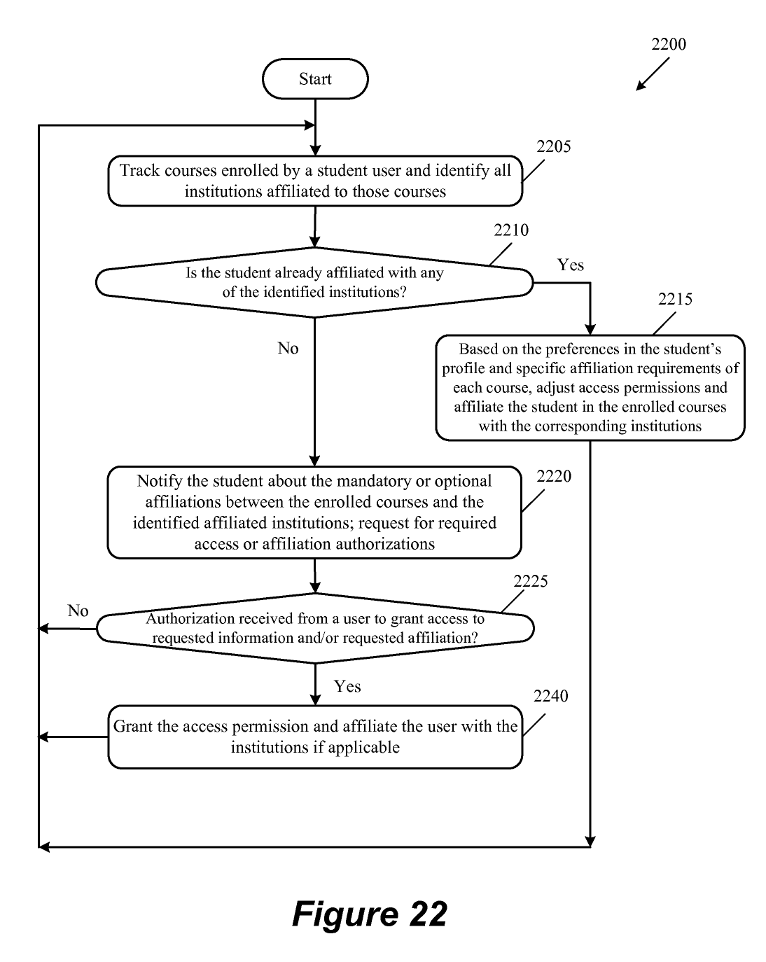

FIG. 22 conceptually illustrates a process 2200 for automatically identifying affiliations in some embodiments of the invention. As shown, the process tracks (at 2205) courses enrolled by each student user and identifies institutions that are affiliated with the identified courses. The process then determines (at 2210) whether the student is already affiliated with the identified institutions. If yes, based on the preferences set by the student in student's profile and based on the specific affiliation requirements of each course, the process automatically adjusts access permissions and affiliates the student in the enrolled courses with the corresponding institutions. For instance, a user in some embodiments can set a preference to be automatically affiliated with a certain institutions once those institutions become affiliated with any courses that the student has enrolled. The process then proceeds to 2205 which was described above.

Otherwise, the process notifies (at 2220) the student about the mandatory or optional affiliations between the enrolled courses and the identified affiliated institutions and to request for required access or affiliation authorizations. For instance, when a course is offered through a grant, the granting institution (through the corresponding grant administrator user) in some embodiments can requires grade report, evaluation report, statistical analysis, outcome report, etc. for the students.

The process then determines (at 2225) whether authorization is received from a user to grant access to requested information and/or requested affiliation. If not, the process proceeds to 2205 which was described above. Otherwise, the process grants the requested access permissions and/or affiliates the user with the requesting institution. A similar process in some embodiments is used to automatically identify affiliations for instructor users.

C Course Material and Publication

Some embodiments allow instructors to publish and distribute their class materials or notes (e.g., topic notes, book chapters, full text books, exam samples, etc.) via the system's network of students and instructors. Instructors utilize the system and its network of users to publish and distribute his/her course materials for free or for a charge. One difference between the prior art system and different embodiments of the present invention is the scope of data available to the users. For instance, a math instructor can search the students' profiles to find the students who have the lowest 5% ranking in their math classes. The instructor then sends the students a message with a link to his math notes and materials and an instruction of how they can access them. Then the students can view the rating and reviews for those materials and decide if they want to purchase them.

In the case of for-fee distribution, the system utilizes different usage and charge methods to allow other users to access the published material. For instance a biology instructor whose materials have the highest level of rating can search the system databases for biology instructors with the same rating levels and offer them to share materials.

For published course materials (either for-free or for-a-fee, public or selective access), comprehensive rating methodology is enabled in some embodiments of the invention. The disclosed system allows student and instructor users (registered users only) to rate and evaluate a course's material based on different criteria. Once the ratings are collected, different criteria and options are used to calculate and demonstrate overall rating results for a course material. For instance, a user can select to view rating results for a course material based on collected data from only: (i) instructor users, (ii) student users from the instructor's institution, (iii) student users from all institutions, (iv) student users with grades B and better, (v) students users in top 10% of their classes, etc.

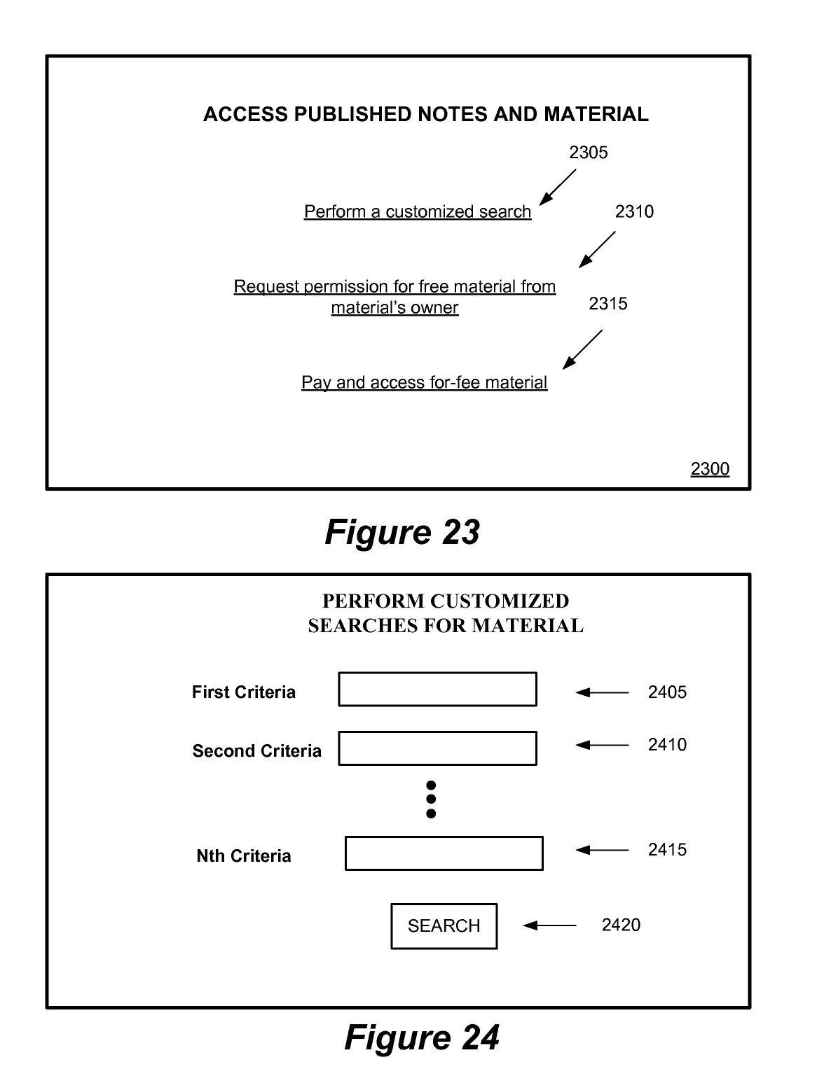

Some embodiments provide user interfaces for the users to access published notes and material. FIG. 23 conceptually illustrates a user interface 2300 for accessing the published material in some embodiments of the invention. As shown, several links are provided for the users to perform a customized search 2305, request permission for free material from material's owner 2310, and pay and access the for-fee material.

FIG. 24 conceptually illustrates a user interface that is provided when a user selects link 2305 to perform customized searches in some embodiments. As shown, the user can enter several search criteria 2405-2415 such as keys words for different topics, author name, material assessment results, number of courses that have used the material as course material or as extra reading material, etc. A search is performed once the search button 2420 is selected. Once the user identifies a desired material, the user can send a request for free material or can pay and gain access to for-fee material.

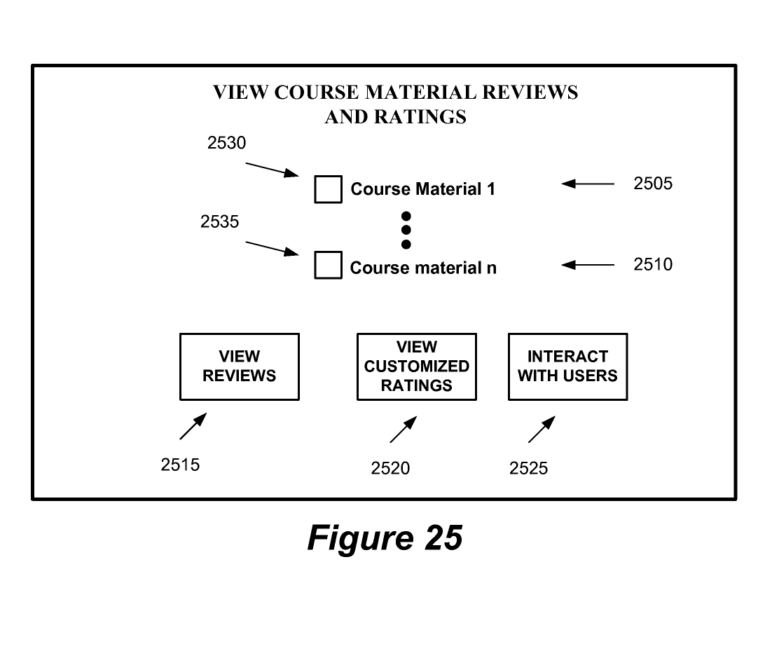

FIG. 25 conceptually illustrates a user interface that is provided for viewing course material reviews and ratings in some embodiments of the invention. This user interface is displayed after the user performs a search for material and identifies several course or study materials to review and evaluate. As shown in the example of FIG. 25, several course materials 2505-2510 are identified based on a prior search. The user can select one or more of these materials, e.g., by using select buttons 2530-2535. The user can then view reviews for the material, view customized ratings for the material, or interact with other users (students, instructors, publishers, etc.) about the material by selecting buttons 2515-2525 respectively.

Some instructors may want to publish course material as advertisement for their quality, transfer of knowledge to all, for publicity and fame, etc. Also some instructors may want to make profit from their educational material in a fee-based model. FIG. 26 conceptually illustrates a process 2600 for an instructor user to publish his/her course material to users not enrolled in his/her course. The process is also utilized by publisher users to publish educational material to the online learning system users. Published course material then become accessible and searchable by all users and no longer need any explicit authorization by the content owner (e.g., the instructor). As shown, the process receives course and other educational material from a user and adds the material to the user account. In some embodiments, users such as instructors, publishers, students, etc. can publish course or educational material. Examples of such material are full books, book chapters, course notes, exam samples, exam solutions, software packages, software tutorials, sample, etc. The received material are uploaded and stored in the publishing user's account.

Next, the process receives (at 2610) a request from the publishing user to publish one of the course materials. The process then receives (at 2615) (e.g., through a graphical user interface) definition of a set of users that the publishing user wants to have access to the course material. Examples of the set of users are all users, user in the U.S., users enrolled with a particular university, users enrolled in a particular course, etc.

The process then receives (at 2620) price for the item for the defined set of users. For instance, no charge, one time $1 flat fee, $1 per download, $1 per day, a packaged deal, etc. The process then determine (at 2625) whether more user price groups are to be defined. If yes, the process proceeds to 2615 to receive definition of the next set of users. Otherwise, the process publishes and/or distributes (at 2630) the course material as configured by the publishing user. The process then collects (at 2635) payments and credits the payments to the publishing user's account. The process then exits.

D. Access Control

Some embodiments provide an instructor with a customizable “access matrix” where at any time, the instructor can selectively set and filter the users (students or other instructors) with access to his/her current or past course material. The instructor specifies some materials as out of course materials and sets them accessible by a group of users and blocked to other groups of users. For instance, students who are registered in course “math 101” are authorized to access to all materials, assignments and projects for that course. But students who are observing the course are authorized to access the notes, but not the assignments and projects.

The instructor in some embodiments creates his/her own groups with different level of access to available material. In this manner an individual user or a group of users can have different levels of visibility and access to the instructor's material. The instructor can also allow public access (all signed up users) to certain course materials. By contrast, in the current prior art e-learning systems the institution controls students' access to different courses and materials.

E Course Material Matching and Recommendations

Some embodiments utilize different methods for identifying and matching similar and relevant courses. Based on these methods, the system updates and maintains data matrices showing the similarity and/or degree of correlation between courses and learning material. Some exemplary methods include: (i) if two courses are using the same objectives and requirements in their assessment templates, this is an indication of similarity and (ii) if two courses are linking to the same textbook, articles, etc., (as suggested learning material) those two courses are considered more similar.

Information elements to update the correlation matrices include the search result behaviors and tagging and linking of course materials by users. For example, when a student user searches for material and finds relevant helpful material, he/she can save the desired items by tagging and saving them under a course under his/her account. The system then utilizes these tagging results and corresponding graphs by all users to improve search results and make relevant material suggestions to users.

F. History of User Activities

Some embodiments maintain a history of student and instructor users' activities. These embodiments save the educational and professional history of users. For students, this history includes: all past courses taken in different institutions (which covers institutions and instructors offering those courses), grades, class rankings, reviews/feedbacks by instructors, course materials, submitted homework, etc. For instructors, this history includes: all past courses offered (which covers institutions affiliated with while offering those courses), student reviews and comments, assessment and evaluation outcomes, course materials, review/comments/ratings of offered course materials, etc.

Each user (student or instructor) has full control on accessibility of about history elements by other users through comprehensive customizable “access matrices”. For instance, a student user authorizes a list of “instructor” users to have access to history of his/her information elements. As another example, an instructor user authorizes a list of “grant administrators” to have access to his/her history information elements.

The system keeps and maintains this history as long as the user remains a member of the system. For instance, the system keeps all the materials, assignments' answers and submitted projects of student users. In addition, every user is provided a remote storage capacity by the system that is used to store data in the cloud. This space is partitioned into subsections dedicated to the courses that student users are enrolled in or courses created by instructor users. Users save all their files and activities (intermediate work-in-progress files, documents, software source code, etc.) related to each course (the ones that are not necessarily submitted for the course) in the dedicated space for that course. The system archives and freezes all this information when the course is finished for the user's future access and reference.

G. Category of Courses Offered

The categories of courses offered include: (i) an individual offering basic tutoring classes, (ii) an individual offering basic college courses such as math/calculus, high-school biology, etc., (iii) instructors developing online course offerings independent of specific institutions, (iv) individuals offering other types of instructional classes such as cooking classes, classes for various hobbies such as chess playing, guitar lessons, etc., (v) corporations offering training to employees, (vi) extracurricular school lessons and activities, (vii) companies offering courses on operating and working with their products, etc. In the context of this invention, the terms “educational”, “instructor”, and “student” are used broadly to refer to any learning interaction, any individual providing some sort of instruction or advice or lecture or presentation, and any individual interested in signing up to access the material for learning or general knowledge. These terms are not used to refer exclusively to the educational experience that is limited to school, college, or university environments.

H. Grade and Course Material Exchange

A customizable interface is provided in some embodiments where final grades of enrolled students are exchanged with the database and servers of the corresponding educational institutions. The disclosed system is not affiliated with any institution and functions independently. However, the system provides an interface and the technology where instructors can send the enrolled students' grades to the corresponding educational institution.

An instructor user uses the system to enter and process all grades for homework, midterms, finals, projects, etc. At the end, student users enrolled in a course receive a final grade in the system. The instructor then uses that final grade in the system and passes that as the grades for enrolled students towards their degrees. In some embodiments, the system provides an Application Programming Interface (API) to an institution's internal software so that grades are communicated electronically through that API. In some embodiments, the instructor user saves final grades into a file (as text, Excel spreadsheet, etc.) and then uses that file data to upload grades to the institution's grade database.

Some embodiments provide an API for users to port or exchange course material and information from existing course management systems. For instance an instructor user that already has an account with another online educational system (with some courses already set up there) utilizes the provided API to exchange course material (notes, instructions, homework, solutions, etc.) between the two systems. If the user provides the system with his/her username and password for the other online system, the system automatically extracts all his/her data (e.g., notes, assignments, and projects) and transfers them to his/her account in the disclosed system under a new course and consistent with the system's format and infrastructure. This option is provided to facilitate the creation of new courses under the system (just as a starting point) for users who are migrating from other course management systems. Once the migration for a course is done through the provided API, the instructor user is then able to make adjustments and upgrades to the migrated material and the course by and taking advantage of all other tools and options provided by the system.

I. Statistical Analysis

Some embodiments provide tools to perform comprehensive statistical analysis based on public or private information elements related to student and instructor users. The system utilizes its comprehensive database on students, instructors, courses, materials, rankings, ratings, reviews, schools, departments, major programs, job postings, etc. and creates reports, charts and comparison studies.

J. Assessments

Some embodiments provide “assessment packages”. An assessment package includes course objectives and a questioner matrix which evaluates and quantifies the course performance on each course objectives. Additionally an assessment package in some embodiments contains association between course objectives and the students' grades and performance on homework and projects covering each course objective. The course objectives in some embodiments are categorized as “desired” or “required” items to be learned in the course.

One metric used in some embodiments for assessing and evaluating a course (besides other methods described herein) is how successfully a course contributes to the outcome of other subsequent courses that use this course as a prerequisite. For instance, assume course A has certain topics as course objectives. Those course objectives are given as prerequisites for course B. In this case, if a student takes course A followed by course B, then this student's success in course B (e.g., when the student receives a good grade in course B) is used as an indicator for performance of course A. In this example, the assessment package for course B includes a list of prerequisites of the course which includes course A. The system uses the high evaluation of course B as an indicator for course A's good performance.

An assessment package in some embodiments contains test questions on materials and objectives that are supposed to be covered in the course (correct answers included). In some assessment packages, students are asked to rate the effectiveness of course material (e.g., book chapters, software, video lectures, etc.) on understanding specific goals of the course. The system collects the above information to rate and suggest learning material per learning objective. For instance if many courses list learning differential equations as a course objective, then many assessment packages in the system collect information on learning tools on differential equations. The collected statistics are used to rate and suggest rating tools for this particular objective.

Assessment packages are used to assess and evaluate courses. A user has the option of using one or more assessment packages to evaluate a course. A combination of assessment packages can be used to assess a program, degree and eventually an institution. Assessment packages are either global where a general assessment package is used by different users or local where a user creates his/her customized assessment package. An example of a general assessment package is an assessment package created by an administrator user and used by all the instructors affiliated with the administrator's institution. The users have the ability to search for existing assessment packages and mix and match different segments from different packages and create a specialized course assessment for their own purpose. Grant administrators can also create their own assessment packages and ask instructors to use them.

When existing assessment packages are used by multiple courses, a comparative analysis between assessment outcomes from different courses is provided by the system. The system creates specialized reports from assessment packages for different user types e.g., grant administrators. For instance an administrator with access to the assessment package data from different courses (for example district principal), is provided with comparative analysis across all courses taught by instructors affiliated by that district. An assessment package itself can be ranked by users e.g., instructors and administrators. The assessment packages with higher rankings would be used by more instructors and administrators.

Some embodiments correlate student's performance with funding grant. As an example when a student receives a scholarship the grant agency administrator can enter the grant's information (amount of grant, start/end dates) to the system and attach the grant data to the student user's account. Once the student user approves the request the grant administrator user will gain access to student's performance for a period of time. The student's performance can include grades, rankings, notes from instructors, homework grades, etc.

Some embodiments correlate course/instructor assessments with teaching/research funding. For instance when an instructor receives a teaching/research fund, the grant agency administrator enters the grant's information (amount of grant, start/end dates) and attaches that grant data to the instructor user's account. Once the instructor user approves the request, the grant administrator user gains access to course/instructor assessments for a period of time. The grant administrator compares the assessments for this instructor against the other instructors' assessments. The grant administrator recommends or enforces certain assessment packages for a period of time.

A grant or institution administrator creates assessment packages and/or templates for different courses and enforces them as default assessment for the courses under his/her affiliation in some embodiments. The benefit is to apply a unified assessment package across different courses. For instance, USC math department chairperson creates a unified assessment for math 101 course and enforces that as the package used by math 101 any time offered by a USC math instructor (i.e., if that course is affiliated with USC math department). As another example, the Los Angeles School District administrator creates an assessment package for course history and enforces all history courses across Los Angeles School District to use that package for their assessment. Instead of creating a new package, such administrator users search for existing packages, select one, and enforce that selected/recommended one to all courses affiliated.

Users' educational profiles are used in some embodiments to accordingly scale or filter the impact of their evaluations in the overall rating and evaluation of a material. Educational profile information elements used to scale and weight the evaluation of a user includes: user functionality (instructor vs. student), user's affiliated school, user's affiliated school, user's geographical area, user's educational history, user's success (ranking, grade, etc.) in past courses, user's specialization major, user's final earned degree, user's own performance evaluations (if student, by his/her instructors, if instructor, by his/her students), user's career status (e.g., companies worked for, years of career experience, latest job position), etc.

Some embodiments rank assessment packages to enable instructors to choose a better package. Assessment packages are be searched and filtered based on the different criteria such as: (i) number of instances a package has been used for different courses (affiliated to different institutions and over different time periods), (ii) filtering based on the frequency of usage by a specific institution (e.g., search for and use packages that are commonly used in courses affiliated with USC), (iii) filtering based on who has created or recommended a particular package (e.g., institution administrators or grant administrators recommendations takes a higher weight), and (iv) students and instructors rating of the assessment packages (e.g., a rating of from 1 to 5).

Some embodiments bundle courses with common roots when creating rating, reviews, assessments, etc. for these courses. For instance, assume that instructor I1 is teaching math 101 in years 2010, 2011, and 2012. Since this is effectively the same course (but offered at different years and to different student users), the system uses this information in some embodiments to combine and collect the ratings, reviews, assessments, etc. for these three courses under a root course math 101. In this case, the user I1 assigns all these three courses under root math 101 for reviews, evaluations, assessments, etc.
1. Graph-Based Joint Assessment

Some embodiments consider the history and trajectory of courses and students over time to assess the performance and outcome of a course or instructor. Each group of events related to a course or a student is considered as a node of the graph which is related to other nodes of the graph by one or more dependencies. If a course (or students enrolled in a course) leads to future successful events (e.g., high performance follow-on courses, successful job acquisitions, successful admission rates, etc.), those subsequent successes are taken into account for adjusting the assessments. Similarly, unsuccessful future events are taken into account for adjusting the assessment. These information elements are utilized in addition to questionnaires and other means provisioned in assessment packages for further improvement in performance quantification.

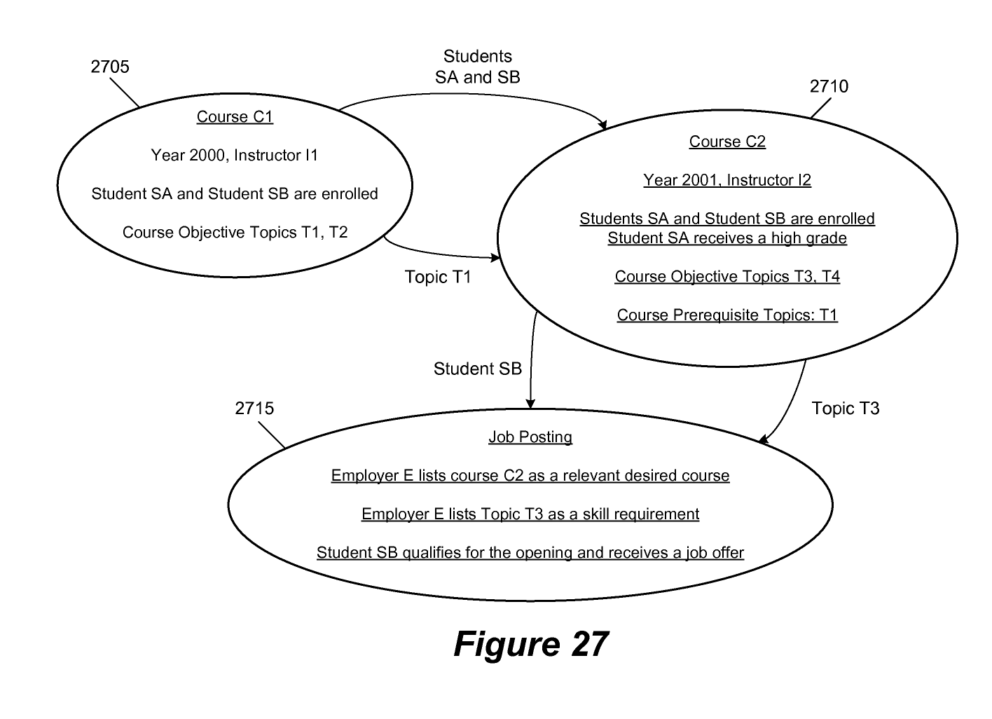

FIG. 27 conceptually illustrates an example of how the interconnections between courses and job postings are used to improve course and instructor assessment accuracy in some embodiments of the invention. In this example, there are links and information elements between the courses and job postings that are utilized for assessment purposes. Such links and interdependencies include: (i) students who advance from course to course, (ii) topics that are common amongst course or are objectives of a course while prerequisite of another course, (iii) skills, topics, courses that are listed as requirements for job postings, and (iv) students who complete a course and successfully receive a job offer in response to a job posting.

As shown in node 2705 in the example of FIG. 27, course C1 is offered by instructor user I1 in year 2000. Students SA and SB are enrolled in this course (several other students are enrolled as well). The course objectives are T1 and T2 (e.g., calculus and differential equations). As shown in node 2710, course C2 is offered by instructor user I2 in the following year (i.e., year 2001). Students SA and SB who have completed course C1 in 2000 are enrolled in course C2 as well. Two new objectives and/or topics T3 and T4 are given for course C2 by the assessment package. Furthermore, topic T1 is given as prerequisites for course C2. Furthermore, as shown in node 2715, employer E creates a job posting with the system and lists course C2 as a relevant desired course for the opening. Employer E also lists topic T3 as a skill requirement for the opening. Student user SB qualifies for the job posting and receives an offer.

The following links and events are detected and identified by the system and used to link the assessment quantifications between the courses. Each event described below triggers an adjustment in assessments for courses C1 and C2 (on top of results out of assessment packages). Since objectives of course C1 (e.g., topics T1) are used as prerequisites of course C2, depending on the number students graduated from C1 and then enrolled in C2, a high overall performance assessment for C2 propagates back to improve C1's assessment through a scaling factor. Vice versa, a negative performance for C2 degrades C1's assessment through a scaling factor.

Students SA and SB's high performance in C2 (e.g., improvement from C1 to C2, higher grades/ranking in C2, etc.) impacts and improves C1's assessment.

Since C2 is listed as a desired course for a job posting, C2's assessment is improved through a weighting factor (depending on the number of job posting listing course C2 as a desired course).

Since a job posting has listed topic T3 as a required skill, in any assessment package that topic T3 is listed as an objective (e.g., course C2), that course objective gets a higher weighting factor in overall assessment calculation.

Since student SB receives a job offer (to the posting by employer E), this event triggers following adjustment in assessment figures: (i) an improvement in the performance assessment figures for course C2 (with some scaling factor) and course C1 (with a different scaling factor) due to the job offer event and the fact that student SB attended courses C2 and C1 with objectives relevant to the job requirements, (ii) questionnaires, ratings, reviews by student SB get a boost in their weighting factor triggered by the job offer event, (iii) triggered by the job offer event, objective T3 gets a higher weight in assessment of course C2's assessment, and (iv) course material (homework, book chapters, notes, applications) that contributed to objective T3 in C2 and T1 in C1 would get a higher rating/review and higher weighting factor in assessments.

K. Networking Among Users

Some embodiments provide for networking among the users (students and instructors) utilizing the “educational” information elements associated with a user's account. A student user's profile exploits user's educational information elements such as: institutions attended, courses taken, course outcomes (if authorized by students), etc. An instructor user's profile exploits user's educational information elements such as: institutions affiliated with, courses taught, published course materials, etc. Some embodiments also exploit the links between member students and instructors to enhance the quality and effectiveness of networking (social or professional) among system's registered users.

### II. System Architecture

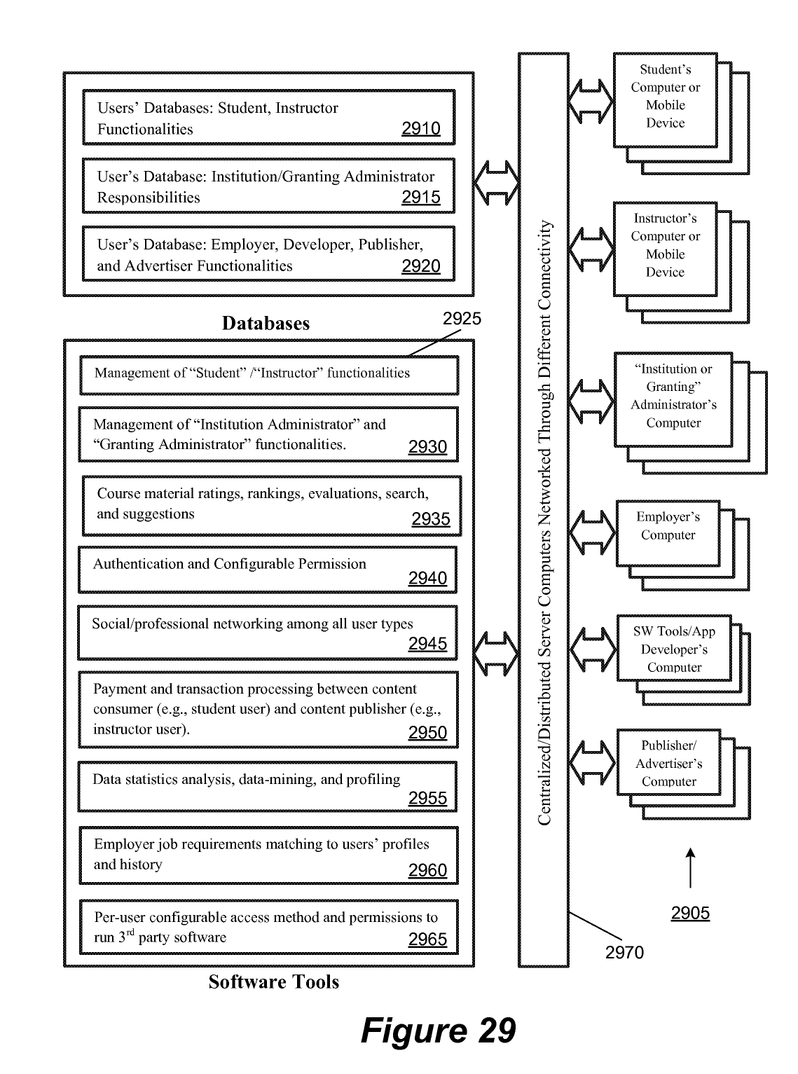

FIG. 29 conceptually illustrates the overall architecture of some embodiments of the invention. As shown, the user devices 2905 interact with databases 2910-2920 and software tools 2925-2965 through a set of centralized or distributed server computers 2970 which are networked through different connectivity. For instance, some users may use wireless link (WiFi, cellular) to connect to the system while others use wired Ethernet, optical link, etc., to connect to the system. Furthermore, different devices can be used to interact with the system (PC with regular web interface, smartphones, iPads).

The user include students, instructors, institution administrators, grant administrators, employers, software tool application developers and other vendors, publishers, advertisers, etc. These users access the system through their computing devices such as computers, mobile devices, PDAs, etc.

A. Examples of Software Tools

FIG. 29 shows several examples of the software tools that are provided in some embodiments of the invention. Management of “Student” and “Instructor” functionalities tool 2925 manages all functionalities related to course management by student and instructor users. Course material uploading, posting, viewing, and downloading are performed by this tool.

Management of “Institution Administrator” and “Grant Administrator” functionalities software tool 2930 manages all functionalities related to “Institution/Grant Administrator”. Granting access to assessment/reviews of corresponding instructors and supporting different performance analysis/metrics are performed by this tool. Various assessment platforms (created by instructor, created by administrator user, ported from other accounts, etc.) are enabled and managed by this tool. Performance tracking and comparative features are provided to analyze the performance of different instructors: (i) over time, (ii) from course to course, (iii) compared to other instructors with comparable courses, (iv) based on different assessment criteria/platforms, (v) course outcome for different percentiles (top 10%, bottom 10%, etc.), and (vi) review/ratings categorized based on rating students' course performance and history. The tool 2930 allows for saving, storing, sharing, and emailing of the reports.

Course material ratings, rankings, evaluations, search, and suggestions software tool 2935 manages and categorizes all evaluations and ratings of courses and course materials. The tasks include: (i) managing assessments/reviews/ratings of courses/instructors/notes by enrolled student users, (ii) managing, filtering, and categorizing ratings of courses/instructors/notes by all other users (e.g., non-enrolled users), (iii) providing suggestions to different users (e.g., students, instructors) on other course materials that may potentially help/interest them based on analyzing the profiles/history of the users, and (iv) providing search capability that is customized based on the user's profile/history using the searching tool.

Authentication and Configurable Permissions software tool 2940 manages login/access authentication for all users as well as all configurable access permissions. This includes managing: (i) permissions to enrolled student users by an instructor user to access course materials, (ii) permissions to institution/grant administrator users by related instructor users to access evaluation/assessment/outcome data, (iii) customized/filtered public access to published items (e.g., only students enrolled in courses math 101, algebra 101 are given access to math 102 course material by its instructor), (iv) permissions by a student user to another user (e.g., prospective employers, admissions offices, research advisors) to access his/her academic history (e.g., courses taken, grades, rankings, evaluations/comments by instructors), (v) permissions by an instructor user to another user (e.g., prospective students, prospective hiring schools) to access his/her academic history (e.g., courses offered, course material, rankings/ratings, assessments, course outcomes, evaluation/comments by students), and (vi) customizable permissions by software providers to allows users to access and run their software offerings (remotely or locally) for free or discounted price over a certain period of time (e.g., grant special permissions to users in certain geographical regions or students enrolled in certain courses).

Social & professional networking among all user types software tool 2945 provides features for social/professional networking among the users. There exist features and capabilities designed and customized considering different usage scenarios of the disclosed system. The tasks include: (i) search capabilities for screening or finding users based on their profile/history or commonality between educational profiles, (ii) networking among the participants of a course or institution (e.g., students and the instructors), (iii) networking capability among student users enrolled in similar courses offered by different institutions, and (iv) professional networking and interaction based on profiles/histories and/or commonalities between educational profiles.

Payment and transaction processing between content consumer and content published software tool 2950 provides transaction processing between content consumers such as student users and content publishers such as instructor users, publishing companies, software vendors, etc. This tool handles payment transactions among the participating users. A content consumer can be a student user, instructor user, etc. A content provider can be any user (student, instructor), software vendor (e.g., offering access to software licenses or remote servers), publishers (offering access to text books, book chapters). Payment scenarios supported includes per-item charging, or flat-monthly charging.

Data statistics analysis, data-mining, and profiling tool 2955 analyzes all users' data for different purposes to feed into different tools in the system. This includes (but not limited to): (i) analyzing and categorizing users' profiles in terms of courses taken, technical expertise/skills, grades/rankings, potential future interest in courses/technical-notes, network of linked users, professional/educational trends of other users with common technical profiles, (ii) data-mining of reviews, assessments, ratings of all materials and users by all other users to extract patterns and trends, and (iii) data-mining of professional moves by users of similar background.

Employer job requirements matching to users' profiles and history software tool 2960 analyzes job requirements for job posting by potential employers against professional/technical profiles of the users. The tool then helps with matching and forwarding the job requirements to relevant users. This includes: (i) associating a job posting requirements with technical backgrounds and expertise (e.g., courses taken, level of success in certain courses, evaluations/assessments), (ii) associating a job posting requirements with level of success in certain independent evaluation tests administered by the disclosed system, (iii) quantifying job matching based on similarity/correlation of a user's technical/professional background against that of some reference users, (iv) providing feedback to student users in their educational direction by analyzing the trends in job requirements, (v) allowing potential employers to create detailed job posting requirements based on courses taken, grades/rankings, assessments by certain instructors, technical skills, and (vi) allowing employers to feedback to system their evaluations of their past hires through the disclosed system (level of satisfaction) to enable the system to improve future matches or suggest candidates.

Per-user configurable access method and permissions to run 3rd party software tool 2965 provides the platform to allow software vendors to offer their software tools to selected users to either run the tool on user's computer or allow the user to run the tool on remote servers. This includes: (i) offering software access for free to users enrolled in certain courses or instructors offering certain courses, (ii) offering software access to users for limited time only for free or for a discounted low price, (iii) offering software access to users to only exercise a limited set of runs and executions, (iv) linking software offerings to job posting requirements and allowing users to exercise and to train for using a software in connection to a job posting, and (v) allowing software vendors to create courses on training for using subsets of their tools (along with final exams, evaluations, mutual assessments).

B. Examples of Databases

FIG. 29 also shows several examples of databases utilized by some embodiments of the invention. As shown, these databases include users databases 2910 for student and instructor functionalities, users databases 2915 for institution and grant administrator responsibilities, and users databases 2920 for employer, developer, publisher, and advertiser functionalities. The entire database is maintained by the system and is in some embodiments distributed geographically for improved speed and security. For student users (or users with student roles), the database stores all courses taken (all course material, course related communications, forums, customizations, homework/project submissions, etc.). For instructor users, the database stores all courses offered (material, homework, projects, course related communications, forums, received returns from students). For institution /grant/admission users, the database stores all active/closed links and communications, list of instructor and student users of relevance, and snapshots of student/instructor data for ease of access.

The users do not need to maintain any local storage or copy for any of their data. All intermediate data (unfinished project, documents, etc.) is uploaded to user's database under a dedicated storage to that user and topic for future continuation or archiving at the end. The database is partitioned into sub-sections allocated for different functionalities and purposes. All databases are revision-controlled (the difference from time1 to time2 stored and recorded) to allow users to access older revisions (for different time stamps) for a particular piece of data.

### III. Electronic System

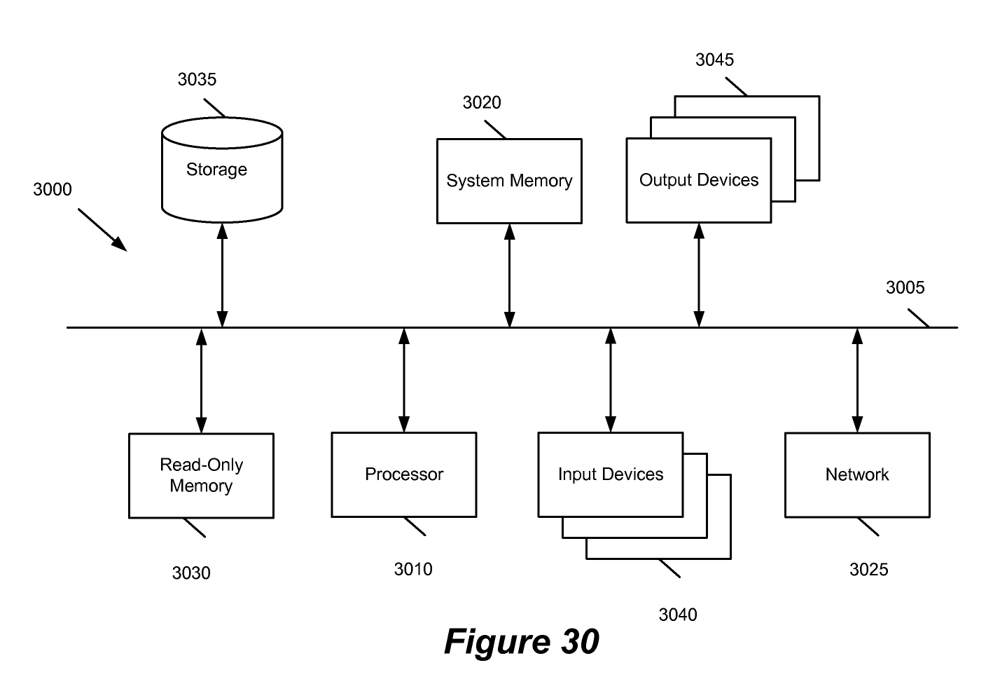

FIG. 30 conceptually illustrates an electronic system 3000 with which some embodiments of the invention are implemented. The electronic system 3000 may be a computer (e.g., a desktop computer, personal computer, tablet computer, server, etc.), phone, PDA, or any other sort of electronic or computing device. Such an electronic system includes various types of computer readable media and interfaces for various other types of computer readable media. Electronic system 3000 in some embodiments includes a bus 3005, processing unit(s) 3010, a system memory 3020, a network 3025, a read-only memory 3030, a permanent storage device 3035, input devices 3040, and output devices 3045.

In some embodiments, customized electronic systems and devices are offered by the system (or offered by other vendors certified by the system) that allow free (or subsidized) access to wireless broadband data (3G/LTE cellular, WLAN WiFi) for as long as the electronic device is accessing the disclosed educational system through a web interface or dedicated application (e.g., iPad™ Application). Furthermore, parents or educational institutions can subsidize or pay for the Internet connection as long as the data traffic is to/from the system.

The bus 3005 collectively represents all system, peripheral, and chipset buses that communicatively connect the numerous internal devices of the electronic system 3000. For instance, the bus 3005 communicatively connects the processing unit(s) 3010 with the read-only memory 3030, the system memory 3020, and the permanent storage device 3035.

From these various memory units, the processing unit(s) 3010 retrieves instructions to execute and data to process in order to execute the processes of the invention. The processing unit(s) may be a single processor or a multi-core processor in different embodiments.

The read-only-memory (ROM) 3030 stores static data and instructions that are needed by the processing unit(s) 3010 and other modules of the electronic system. The permanent storage device 3035, on the other hand, is a read-and-write memory device. This device is a non-volatile memory unit that stores instructions and data even when the electronic system 3000 is off. Some embodiments of the invention use a mass-storage device (such as a magnetic or optical disk and its corresponding disk drive) as the permanent storage device 3035.

Other embodiments use a removable storage device (such as a floppy disk, flash memory device, etc., and its corresponding disk drive) as the permanent storage device. Like the permanent storage device 3035, the system memory 3020 is a read-and-write memory device. However, unlike storage device 3035, the system memory 3020 is a volatile read-and-write memory, such a random access memory. The system memory 3020 stores some of the instructions and data that the processor needs at runtime. In some embodiments, the invention's processes are stored in the system memory 3020, the permanent storage device 3035, and/or the read-only memory 3030. For example, the various memory units include instructions for processing multimedia clips in accordance with some embodiments. From these various memory units, the processing unit(s) 3010 retrieves instructions to execute and data to process in order to execute the processes of some embodiments.

The bus 3005 also connects to the input and output devices 3040 and 3045. The input devices 3040 enable the user to communicate information and select commands to the electronic system. The input devices 3040 include alphanumeric keyboards and pointing devices (also called “cursor control devices”), cameras (e.g., webcams), microphones or similar devices for receiving voice commands, etc. The output devices 3045 display images generated by the electronic system or otherwise output data. The output devices 3045 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 30, bus 3005 also couples electronic system 3000 to a network 3025 through a network adapter (not shown). In this manner, the computer can be a part of a network of computers (such as a local area network (“LAN”), a wide area network (“WAN”), or an Intranet, or a network of networks, such as the Internet. Any or all components of electronic system 3000 may be used in conjunction with the invention.

Many of the above-described features and applications are implemented as software processes that are specified as a set of instructions recorded on a computer readable storage medium (also referred to as computer readable medium, machine readable medium, machine readable storage). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of this specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. In addition, a number of the figures (e.g., FIGS. 8, 16-22, and 26) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

What is claimed is:

1. A method of affiliating a plurality of institutions with an independent online learning system, wherein the independent online learning system is not hosted or maintained by any of said plurality of institutions, the method comprising:
registering a user as an instructor user;
registering a plurality of users as administrator users, each administrator user affiliating with a corresponding institution in the plurality of institutions;
receiving material for an online course from the instructor user;
sending a request to each administrator user in the plurality of administrator users requesting the online course to be affiliated with the corresponding institution; and
affiliating the online course with each institution after receiving an authorization for the requested affiliation from the corresponding administrator.

2. The method of claim 1 further comprising receiving a set of criteria from each of at least two institutions affiliated with said online course, wherein each set of criteria comprises different criteria for grading students enrolling in the online course.

3. The method of claim 1 further comprising receiving a set of criteria from each of at least two institutions affiliated with said online course, wherein each set of criteria comprises different criteria for assigning homework to students enrolling in the online course.

4. The method of claim 1 further comprising:
enrolling a student in said online course;
receiving a request to affiliate the student in the online course with a first institution in the plurality of institutions; and
affiliating the online course with the first institution after receiving an authorization to affiliate the student to the first institution for said online course.

5. The method of claim 4 further comprising:
receiving a request to affiliate the student in the online course with a second institution in the plurality of institutions;
affiliating the online course with the second institution after receiving an authorization to affiliate the student to the first institution for said online course;
receiving a first grade for the student in the online course based on a first set of criteria set for the first institution; and
receiving a second grade for the student in the online course based on a second set of criteria set for the first institution, wherein the first and second grades are different.

6. A method of making a student records in an online learning system accessible to a guardian of the student, the method comprising:
registering a user as a student user in the online learning system;
creating a set of online records for the student based on the student participation in a set of online courses;
registering a user as a guardian user in the online learning system;
receiving a request from the guardian user to have access the online records of the student user;
sending a request for said access to the student user; and
authorizing the guardian user to access a set of online records of the student based on a set of access authorizations received from the student user.

7. The method of claim 6, wherein the student user is a first student user, the method further comprising:
registering a user as a second student user in the online learning system;
creating a set of online records for the second student based on the second student participation in a set of online courses;
receiving a request from the guardian user to have access the online records of the second student user;
sending a request for said access to the second student user; and
authorizing the guardian user to access a set of online records of the second student, wherein a level of the guardian user access to the online records of the first student is different than a level of the guardian user access to the online records of the second student based on a difference between the set of access authorizations received from the first student user and a set of access authorizations received from the second student.

8. A method of improving assessment of courses in an online learning system, the method comprising:
identifying a set of courses offered in the online learning system over a period of time, wherein a first course in the set of courses is a prerequisite of a second course in the set of courses;
identifying a set of events corresponding to the second course; and
adjusting an assessment of the first course based on an event identified for the second course.

9. The method of claim 8, wherein the set of events comprises a grade a student receives in the second course.

10. The method of claim 8, wherein the set of events comprises a user registered as an employer in the online learning system identifying a topic in the second course as a skill requirement for employment.

11. The method of claim 8, wherein the set of events comprises a user registered as an employer in the online learning system identifying the second course as a relevant course for employment.

12. The method of claim 8 further comprising registering a student in the second course after the student has completed the first course, wherein the set of events comprises a grade the student receives in the second course.

13. A computer readable medium storing a program for affiliating a plurality of institutions with an independent online learning system, wherein the independent online learning system is not hosted or maintained by any of said plurality of institutions, the computer program executable by a computing device, the computer program comprising sets of instructions for:
registering a user as an instructor user;
registering a plurality of users as administrator users, each administrator user affiliating with a corresponding institution in the plurality of institutions;
receiving material for an online course from the instructor user;
sending a request to each administrator user in the plurality of administrator users requesting the online course to be affiliated with the corresponding institution; and
affiliating the online course with each institution after receiving an authorization for the requested affiliation from the corresponding administrator.

14. The computer readable medium of 13, wherein the computer program further comprises a set of instructions for receiving a set of criteria from each of at least two institutions affiliated with said online course, wherein each set of criteria comprises different criteria for grading students enrolling in the online course.

15. The computer readable medium of claim 13, wherein the computer program further comprises a set of instructions for receiving a set of criteria from each of at least two institutions affiliated with said online course, wherein each set of criteria comprises different criteria for assigning homework to students enrolling in the online course.

16. The computer readable medium of claim 13, wherein the computer program further comprises sets of instructions for:
enrolling a student in said online course;
receiving a request to affiliate the student in the online course with a first institution in the plurality of institutions; and
affiliating the online course with the first institution after receiving an authorization to affiliate the student to the first institution for said online course.

17. The computer readable medium of claim 16, wherein the computer program further comprises sets of instructions for:
receiving a request to affiliate the student in the online course with a second institution in the plurality of institutions;
affiliating the online course with the second institution after receiving an authorization to affiliate the student to the first institution for said online course;
receiving a first grade for the student in the online course based on a first set of criteria set for the first institution; and
receiving a second grade for the student in the online course based on a second set of criteria set for the first institution, wherein the first and second grades are different.

18. A computer readable medium storing a program for making a student records in an online learning system accessible to a guardian of the student, the computer program executable by a computing device, the computer program comprising sets of instructions for:
registering a user as a student user in the online learning system;
creating a set of online records for the student based on the student participation in a set of online courses;
registering a user as a parent user in the online learning system;
receiving a request from the parent user to have access the online records of the student user;
sending a request for said access to the student user; and
authorizing the parent user to access a set of online records of the student based on a set of access authorizations received from the student user.

19. The computer readable medium of claim 18, wherein the student user is a first student user, the computer program further comprising sets of instructions for:
registering a user as a second student user in the online learning system;
creating a set of online records for the second student based on the second student participation in a set of online courses;
receiving a request from the parent user to have access the online records of the second student user;
sending a request for said access to the second student user; and
authorizing the parent user to access a set of online records of the second student, wherein a level of the parent user access to the online records of the first student is different than a level of the parent user access to the online records of the second student based on a difference between the set of access authorizations received from the first student user and a set of access authorizations received from the second student.

20. A computer readable medium storing a program for improving assessment of courses in an online learning system, the computer program executable by a computing device, the computer program comprising sets of instructions for:
identifying a set of courses offered in the online learning system over a period of time, wherein a first course in the set of courses is a prerequisite of a second course in the set of courses;
identifying a set of events corresponding to the second course; and
adjusting an assessment of the first course based on an event identified for the second course.

21. The computer readable medium of claim 20, wherein the set of events comprises a grade a student receives in the second course.

22. The computer readable medium of claim 20, wherein the set of events comprises a user registered as an employer in the online learning system identifying a topic in the second course as a skill requirement for employment.

23. The computer readable medium of claim 20, wherein the set of events comprises a user registered as an employer in the online learning system identifying the second course as a relevant course for employment.

24. The computer readable medium of claim 20, wherein the set of instructions further comprises a set of instructions for registering a student in the second course after the student has completed the first course, wherein the set of events comprises a grade the student receives in the second course.
